(19) United States
(12) Patent Application Publication
(10) Pub. No.: US 2015/0116505 A1
(43) Pub. Date: Apr. 30, 2015

(54) MULTIPLE MEANS OF TRACKING

(71) Applicant: JIGABOT, LLC, Highland, UT (US)

(72) Inventors: Richard F. Stout, Highland, UT (US); Kyle K. Johnson, Eagle Mountain, UT (US); Eric Christensen, Draper, UT (US)

(21) Appl. No.: 14/589,565

(22) Filed: Jan. 5, 2015

Related U.S. Application Data
(63) Continuation-in-part of application No. 14/045,445, filed on Oct. 3, 2013.
Application No. 14/045,445 is a continuation-in-part of application No. 14/502,156, filed on Sep. 30, 2014.
(60) Provisional application No. 61/744,846, filed on Oct. 4, 2012.
(60) Provisional application No. 61/964,482, filed on Jan. 6, 2014.
(60) Provisional application No. 61/964,473, filed on Jan. 6, 2014.
(60) Provisional application No. 61/964,481, filed on Jan. 6, 2014.
(60) Provisional application No. 61/964,483, filed on Jan. 6, 2014.
(60) Provisional application No. 61/964,495, filed on Jan. 6, 2014.
(60) Provisional application No. 61/965,046, filed on Jan. 18, 2014.
(60) Provisional application No. 61/965,444, filed on Jan. 30, 2014.
(60) Provisional application No. 61/965,967, filed on Feb. 10, 2014.
(60) Provisional application No. 61/965,444, filed on Jan. 30, 2014.
(60) Provisional application No. 61/965,048, filed on Jan. 18, 2014.

(51) Int. Cl. G01S 3/786; H04N 5/232

(52) U.S. Cl. CPC G01S 3/7864; H04N 5/23216
USPC 348/169

(57) ABSTRACT

A system for tracking a cinematography target comprises an emitter configured to attach to a target and to provide a tracking indicator. The system also comprises a tracker configured to receive tracking data from a separate tracking data reception device and based upon the received tracking data to actuate one or more motors that cause an attached cinematography device to point towards the tracking indicator. Further, the tracking data reception device can be configured to generate information relating to the location of the tracking indicator. In particular, the tracking data reception device can comprise one or more sensor modules that are configured to identify a location of the tracking indicator relative to the tracking data reception device. The system can also comprise a user interface device configured to receive commands from a user and communicate the commands to the tracker.

### CROSS-REFERENCE TO RELATED APPLICATIONS

This application claims priority to U.S. Provisional Patent Application Ser. No. 61/964,482 filed on Jan. 6, 2014, entitled “SUPPLEMENTARY SENSORS IN A TRACKING SYSTEM SYSTEM,” and to U.S. Provisional Patent Application Ser. No. 61/964,473 filed on Jan. 6, 2014, entitled “TRACKING SYSTEM THAT CAN LEARN,” and to U.S. Provisional Patent Application Ser. No. 61/964,481 filed on Jan. 6, 2014, entitled “INTEGRATING METHODS FOR ENHANCED FUNCTIONING OF A TRACKING SYSTEM,” and to U.S. Provisional Patent Application Ser. No. 61/964,483 filed on Jan. 6, 2014, entitled “3D VISION AND TRACKING WITHIN A TRACKING SYSTEM,” and to U.S. Provisional Patent Application Ser. No. 61/964,495 filed on Jan. 6, 2014, entitled “TRACKING SYSTEM VIA TRIANGULATION,” and to U.S. Provisional Patent Application Ser. No. 61/965,046 filed on Jan. 18, 2014, entitled “SMARTPHONE TRACKING METHOD & DEVICE,” and to U.S. Provisional Patent Application Ser. No. 61/965,444 filed on Jan. 30, 2014, entitled “GRID & ANGULAR DATA TRACKING WITHIN A TRACKING SYSTEM.” Additionally, this application is a continuation-in-part of U.S. patent application Ser. No. 14/045,445 filed on Oct. 3, 2013, entitled “COMPACT, RUGGED, INTELLIGENT TRACKING APPARATUS AND METHOD,” which claims priority to U.S. Provisional Patent Application Ser. No. 61/744,846 filed on Oct. 4, 2012, entitled “COMPACT, RUGGED, INTELLIGENT TRACKING APPARATUS AND METHOD.” Further, this application is a continuation-in-part of U.S. patent application Ser. No. 14/502,156 filed on Sep. 30, 2014, entitled “SYSTEM FOR AUTOMATICALLY TRACKING A TARGET,” which claims priority to U.S. Provisional Patent Application Ser. No. 61/965,967 filed on Feb. 10, 2014, entitled “3D AND FACIAL TRACKING,” and to U.S. Provisional Patent Application Ser. No. 61/965,444 filed on Jan. 30, 2014, entitled “GRID & ANGULAR DATA TRACKING WITHIN A TRACKING SYSTEM,” and to U.S. Provisional Patent Application Ser. No. 61/965,048 filed on Jan. 18, 2014, entitled “INTEGRATING NATIVE VIDEO WITHIN A TRACKING SYSTEM.”

All the aforementioned applications are incorporated by reference herein in their entirety.

### BACKGROUND OF THE INVENTION

One reason that video and film production is difficult or expensive, is because it requires skilled labor: people who can operate cameras, lights, microphones, or similar devices with skill. Cameras, lights, microphones, and other equipment will, at various times, be hand held, or otherwise operated by trained individuals (for best effect), while actors, athletes, or other subjects are being filmed, lit, and recorded.

Recently, with the market arrival of low cost, high quality digital recorders, many non-professional and professional consumers have increasingly used recorders to document a variety of different events. For example, many consumers create films of themselves or others performing extreme sports, such as rock climbing, skydiving, motor cross, mountain biking, etc. Similarly, consumers are able to create High Definition quality films of family events, such as reunions, sporting events, graduations, etc. Additionally, digital video recorders have also become more prevalent in professional and industrial settings. For example, law enforcement departments have incorporated video recorders into police cruisers.

While recent advances in film and video creation and production have allowed consumers and professionals to easily create high quality videos of various events, it can still be difficult for consumers and professionals to acquire the quality and perspective that they may desire in their footage. For example, smoothly operating a camera—panning and tilting it—as a subject moves about in front of it—is difficult even for professionals. Additionally, an individual may desire to record him- or herself snowboarding down a particular slope. One will understand the difficulty the individual would have in simultaneously filming themselves from a third person perspective, such as when they are skiing past a camera that is being swiveled on a tripod by an operator to keep them “in frame.” Similarly, a police officer may desire to record their interactions with the public, but a dash-mounted recorder only provides a limited and static field of view.

Accordingly, there is a need for systems, methods, and apparatus that can gather video footage of desired events and individuals without requiring direct and continual user interaction with the recording device.

### BRIEF SUMMARY OF THE INVENTION

Implementations of the present invention comprise systems, methods, and apparatus configured to track a cinematography target based upon primary and/or secondary tracking data. In particular, implementations of the present invention comprise secondary devices that provide tracking information to the tracking device. The secondary devices can comprise the emitter, supplemental tracking devices, emitter location generators, and other similar devices. Additionally, implementations of the present invention comprise methods and systems for tracking an emitter, even when the emitter is not directly visible to the tracking device.

Implementations of the present invention can include a system for tracking a cinematography target that comprises an emitter configured to attach to a target and to provide a tracking indicator. The system also comprises a tracker configured to receive tracking data from a separate tracking data reception device and based upon the received tracking data to actuate one or more motors that cause an attached cinematography device to point towards the tracking indicator. Further, the tracking data reception device can be configured to generate information relating to the location of the tracking indicator. In particular, the tracking data reception device can comprise one or more sensor modules that are configured to identify a location of the tracking indicator relative to the tracking data reception device. The system can also comprise a user interface device configured to receive commands from a user and communicate the commands to the tracker.

An additional implementation of the present invention comprises a computer-implemented method for tracking a cinematography target that has been associated with an emitter. The method can comprise receiving an indication to associate with a separate tracking reception device. The tracking data reception device can comprise one or more sensor modules that are configured to identify a location of an emitter relative to the tracking data reception device. Additionally, the method can comprise receiving secondary tracking data from the tracking reception device. The secondary tracking data can comprise information related to the current location of the emitter. Further, the method can comprise actuating at least one motor to cause an attached cinematography device to point towards the emitter.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts a diagram of an implementation of a tracking system showing some of elements including a tracking device, an emitter, a subject, a mounted device, a UI device, as well as mounting devices and stands (sometimes called by cinematographers “grip devices”) for some of these;

FIG. 2 depicts a detailed block diagram of an implementation of a tracking system showing at least some of its devices, systems and subsystems;

FIG. 3 depicts a block diagram of an implementation of a method effective to implement a system in accordance with the invention;

FIG. 4 depicts a block diagram of an implementation of a method for integrating data for pattern recognition, and for integrating recognition-data results in order to improve tracking and positioning;

FIG. 5 depicts a schematic illustration of an implementation of an emitter or tracking object being tracked by multiple tracking devices which are communicably interconnected in ways that can enhance the tracking of each tracking object;

FIG. 6 depicts a block diagram of an implementation of a supplemental beacon, functionally interconnected with a primary beacon;

FIG. 7 depicts a block diagram of an implementation of a supplemental tracker functionally interconnected with a primary tracker;

FIG. 8 depicts a block diagram for an implementation of a method for integrating primary data from a main emitter and tracker, with supplemental data from a supplemental beacon and supplemental tracker;

FIG. 9 depicts a schematic diagram showing an implementation of how sensor data may be used to determine swivel information for the tracker;

FIG. 10 depicts a schematic diagram illustrating an implementation of how sensory data may be used to determine tilt information for a tracker, and while not explicitly described—and how, by inference, data related to a 3^{rd} axis of rotation might also be used by a tracker to determine angular rotation around that 3^{rd} axis as well;

FIG. 11 depicts a block diagram of an implementation of a method for a smartphone's providing tracking control data to a tracking device where it is used to control tilting and swiveling of motors all effective to implementing the invention;

FIG. 12 depicts a block diagram of an implementation of method for a smartphone's sensing of a tracking object or emitter or of environmental data, then analyzing that data and effecting it in other ways in order to send data to a tracking device effective for enabling the tracking device to successfully frame an emitter or tracking object;

FIG. 13 depicts an illustration of a three-dimensional Cartesian coordinate system showing an implementation of the location of an emitter and a tracker relative to the x-axis and the y-axis;

FIG. 14 depicts an illustration of a three-dimensional Cartesian coordinate system (same as shown in FIG. 13) showing the location of the same emitter and the same tracker, but relative to the z-axis and the y-axis; and

FIG. 15 depicts an illustration of a block diagram of an implementation of a method for employing data from a ELG in order to tilt & swivel & optionally rotate along a 3rd axis in order to aim at the tracking object or emitter, effective for implementing the inventions.

### DETAILED DESCRIPTION OF THE PREFERRED EMBODIMENTS

The present invention extends to systems, methods, and apparatus configured to track a cinematography target based upon primary and/or secondary tracking data. In particular, implementations of the present invention comprise secondary devices that provide tracking information to the tracking device. The secondary devices can comprise the emitter, supplemental tracking devices, emitter location generators, and other similar devices. Additionally, implementations of the present invention comprise methods and systems for tracking an emitter, even when the emitter is not directly visible to the tracking device.

A device called a tracker or tracking device may be created and used to follow an emitter or a subject or a subject wearing an emitter, such that when an emitter moves or a subject moves the devices may both tilt and swivel in order to aim at the emitter or subject. In at least one implementation, a camera or other recording device or other device may be mounted to the tracker. This second device may be called the mounted device. Accordingly, when the tracker tilts and swivels to follow an emitter or subject, the mounted device being attached to the tracker is aimed by the tracker at the emitter or subject. Thus if the mounted device is recording video, the subject is recorded when moving about by the mounted device which is tilting and swiveling to follow it. If the mounted device is a light or a microphone, the subject may be illuminated or audio-recorded as it moves about.

In at least one implementation, a UI device, such as a smartphone or remote control or computer, may be used to configure the tracker or mounted device in ways that meet the user's preferences. Additionally, a grip system may be used to support or grip the tracking device. The grip system may comprise a tripod, a dolly, a flying drone, or any other object to which a tracker may be secured.

While the activity of tracking may be thought of simply as following an RF transmitter, an IR emitter, or person or other subject, there are specialized needs and unique solutions for beneficial tracking which are identified, described, diagrammed in the current invention. For example, one of the needs addressed by this invention is the need for a non-line-of-site means of tracking. For example, if a person wearing an emitter were to walk temporarily behind a fence, for example, or to skate behind a wall, or ski behind some trees, the direct line-of-site connection between the emitter and the tracker may be obstructed, and the entire system and tracker may not be able to function. In such a case as this previously stated, the direct-line-of-site tracking method could benefit from supplemental data regarding how and where the emitter or tracking subject or object may be moving or located. Another benefit provided by the present invention comprises a tracking system that can “learn” or “anticipate” or “configure” itself—thus enabling more responsive, more simple, or more robust tracking. Additionally, in at least one beneficial implementation, multiple tracking devices can track the same emitter or beacon or tracking object, and those tracking devices can communicate with each other (and be aware of where they are located relative to each other), such that even if one tracking device loses a signal and/or line-of-site with the emitter or tracking object, it can still rely upon the other tracking devices in order to continue tracking via triangulation. Additionally, a tracker may receive data from another device within the tracking system, or outside of a tracking system, including coordinate data, relative angular data, or triangulation data from which it may determine how to control its own motor system in order to aim at a tracking object (or receive such instructions from another device). Accordingly, the tracking of all tracking devices can be more continuous even if one or more of the tracking devices loses its emitter signal or line-of-site with the tracking device.

In at least one implementation, it may be useful for a mounted smartphone or similar device such as a tablet or camera to sense a tracking object or tracking environment and to analyze and/or generate data for affecting the motors of an associated but separate tilt and swivel tracker. In this case the tracking device may respond to or be controlled partially or completely by a smartphone or other mounted device. In other words, the tracker may not have its own sensory subsystem at all. In this implementation, the tracking device may not need to be as sophisticated, it might be lighter weight, and it might cost less to produce and sell.

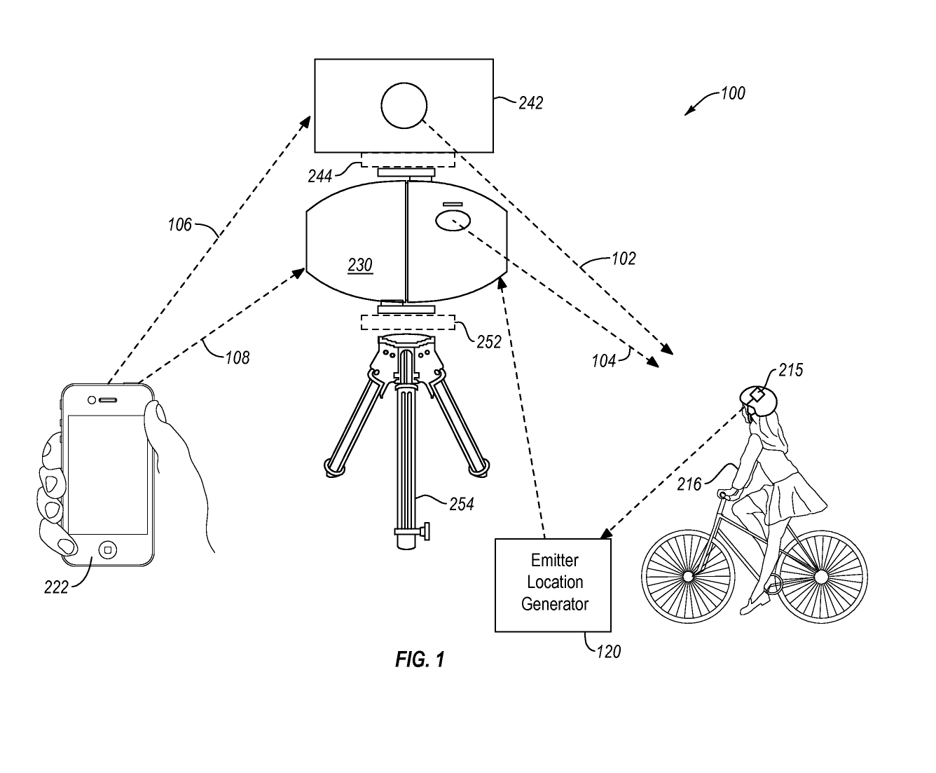

FIG. 1 is an illustration 100 of a non-limiting embodiment of the present invention representing some ways in which the invention may be used. A tracking device 230, which may be called a tracker 230, sits below a mounted device 242, which may be a video camera 242, a light, a microphone, or some other cinematic device. The tracker 230 and the camera 242 are joined via an attachment adapter 244, which serves to tilt and swivel and aim the camera 242, or other mounted device, as the tracker 230 itself tilts and swivels and aims at a tracking object 216 which may be a person or other object.

The mounted camera 242, or other mounted device, may thus face directly toward the tracking object 216, as illustrated by arrow 102. This may be facilitated because the tracker 230 may also be facing directly towards the tracking object 216, as illustrated by arrow 104. The facing direction 104 of the tracker 230 is made possible because the tracker 230 sees or otherwise senses the tracking object 216, which may have an attached emitter 215 or beacon, performs various activities (including sensory and control and positioning activities) in order to affect its aiming 104 at the tracking object 216.

Thus as the tracking object 216 moves about, the tracker 230 aims 104 at it, and the mounted device 242 aims 102 at the tracking object 216 as well. If the mounted device 242 is a camera and is recording a video, the tracking object 216 is thus kept “in frame” and recorded. Because the tracking device 230 can tilt and swivel, it can aim 104 at the tracking object 216 moving in any direction within 3D space (which may include up or down or left or right, or towards or away from the tracking device 230).

The tracking device 230 can be attached via another mount 252 or grip adapter, to a grip device 254 such as a tripod or any number of other devices. The mount or adapter 252 may be especially designed to couple both with the tracker 230 and a particular grip device 254 such as a particular tripod or dolly or bike or helmet or drone/quad-copter and so on. Thus the tracker 230 may be attached to a grip device 254, which may be stationary or moving in any direction of 3D space, such as would be the case if the grip device 254 were a flying drone. Whether the grip device 254 is static or moving, or the tracking object 216 is static or moving, the tracker 230 may aim 104 at the tracking object 216 and the attached mounted device 242 may aim 102 at the tracking object 216.

Additionally, in at least one implementation, a UI device 222, such as a smartphone or tablet or computer or other device, may be capable either directly or indirectly of configuring or controlling or exchanging data with or being controlled by or being configured by (or of performing some other useful interactions with) the tracker 230 and/or the mounted device 242 and/or the grip device and/or the emitter 215. The UI device 222 might enable a user to gain added benefit from his or her tracker 230 or mounted device 242 or grip device 254 or emitter 215. For example, a user may, via a UI device 222, create a “script” that “tells” the tracker 230 to run in a particular way, under certain circumstances.

In at least one implementation, the UI device 222 may be used to configure one or more trackers 230 and/or mounted devices 242 and/or grip devices 254 and/or emitters 215, or to configure one or more of these to communicate with or otherwise affect one or more of the other of these trackers 230 and/or mounted devices 242 and/or grip devices and/or emitters 215. Additionally, the tracker 230 and other devices and systems of illustration 100 may not be required to be connected with UI device 222 in order to provide beneficial use and functionality. In particular, in at least one implementation, the functionality performed by the UI device 222 may also be provided by a user interface integrated into one or more trackers 230 and/or mounted devices 242 and/or grip devices and/or emitters 215.

Accordingly, in at least one embodiment, if a person wants to record themselves from a third-party perspective, with a mounted device 242 (which may be a video camera), while they are moving around, they may do so with the present invention by mounting it via the attachment adapter 244 to the tracking device 230. Nevertheless, there may be many other unique and valuable uses of the invention which have not been specifically enumerated herein, but which are facilitated, and intended by the current invention. For example, it can be readily understood that the mounted device 242 may represent a light or microphone which can be mounted, via another attachment adapter 244 to the tracking device 230, and thus be automatically aimed at a tracking object 216, which one wishes to illuminate or record audio from, without continuous user intervention. As such, implementations of the tracking system 200 perform a unique function and provide clear value.

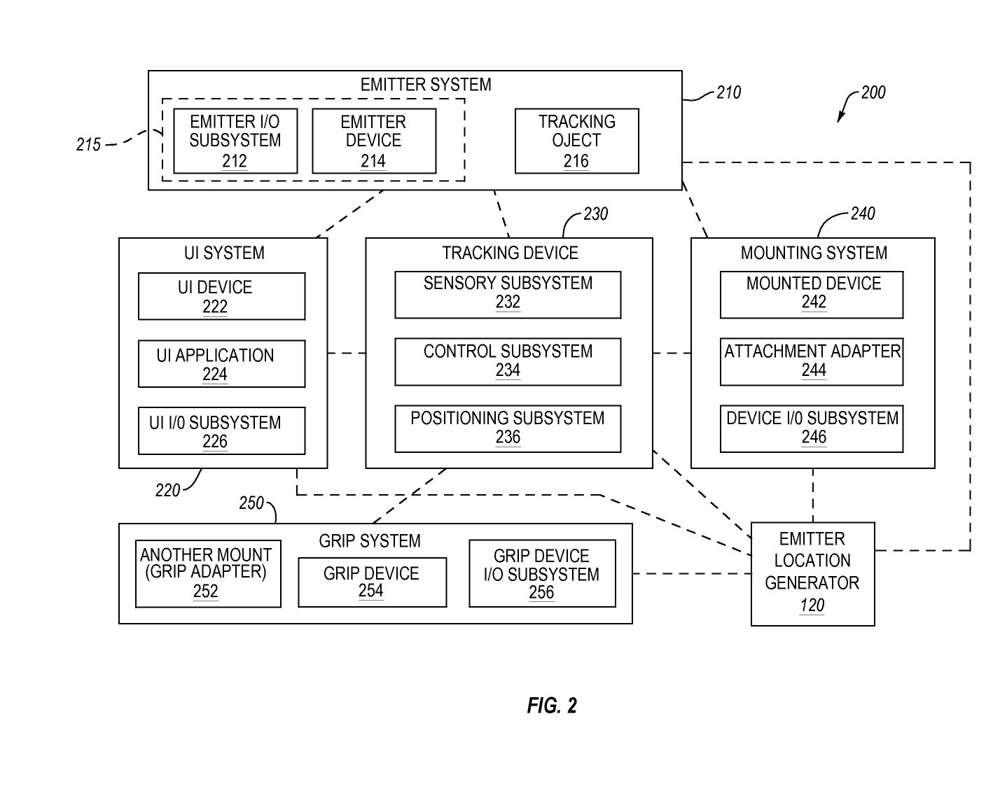

FIG. 2 is an illustration of an implementation of a tracking system or apparatus 200. In at least one implementation, the tracking system 200 may include one or more emitter systems 210 (in whole or part), which are followed or tracked by one or more tracking devices 230 (or “trackers”). The tracking devices 230 may be mounted to one or more mounting systems 240 or grip systems 250. The tracking systems may be configured or automated and otherwise controlled by one or more user interface (UI) systems 220, as may other subsystems (210, 240, or 250) of tracking system 200.

The emitter system 210 may comprise an emitter I/O subsystem 212 and one or more emitter devices 214. The emitter devices 214 may be attached to a person (or persons) or other object (or objects) 216. The emitter I/O subsystem 212 together with the emitter device 214 is sometimes referred to as “the emitter” 215, and may comprise a single device, at least in a preferred embodiment. The emitter 215 may also be a device that has only an emitter I/O subsystem 212 or emitter device 214.

In at least one embodiment, the emitter I/O subsystem 212 is connected with the emitter device 214, and may include RAM, a processor, a Wi-Fi transceiver, a power source, and so on. In various implementations that components and modules of the emitter I/O subsystem 212 are all effective to enable the emitter device 214 to be configured and otherwise controlled directly or from the UI system 220. For example, the emitter I/O subsystem 212 can configure to the emitter system 210 to pulse according to a unique and pre-configured or use-selectable/configurable pulse rate or modulation mode, and to communicate with the tracking device 230 via a transceiver in both the emitter 215 and the tracker 230.

Via the emitter I/O subsystem 212, one or more emitters 215 may be turned on or off, may begin or stop emitting or signaling, may be modulated or pulsed or otherwise controlled in such a way as to be uniquely distinguishably by the tracking device 230. The emitter I/O subsystem 212 may also receive signals from or send signals to an emitter device 214, or the UI system 220, or the tracking device 230, and the mounting system 240 directly or via one or more tracking devices 230 or UI systems 220, or the grip system 250.

The emitter device 214 can be a type of infrared light emitter (such an LED), a supersonic audio emitter, a heat emitter, a radio signal transmitter (including Wi-Fi and Bluetooth), or some other similar emitter device or system or subsystem. Additionally, the emitter 215 can be an inactive system such as a reflective surface from which a color of shape can be discerned by the sensory subsystem 232. In at least one embodiment, one or more emitter devices 214 modulate, pulse, or otherwise control emitted signals or light (visible or non-visible, such as infrared), or sounds, or thermal radiation, or radio transmissions, or other kinds of waves or packets or bundles or emissions, in order to be discernible to a tracking device 230. The tracking device 230 may communicate with the emitter device 215 via the UI system 220, or the emitter I/O subsystem 212 or both, in order to enhance, clarify, or modify such emissions and communications from one or more emitter devices 214.

In at least one embodiment, the emitter devices 214, may be embedded within clothing (such as sport team jerseys, ski jackets, production wardrobe, arm bands, head bands, etc.), equipment (such as football helmets, cleats, hang gliders, surfboards, etc.), props (glasses, pens, phones, etc.), and the like, in order to “hide” the emitter device 215 from being obviously visible to spectators. For example, small emitter devices 215 can be hidden beneath a logo, or integrated with a logo, so as to not be prominently visible. In contrast, fashion accessories, such as hats, shirts, shorts, jackets, vests, helmets, watches, glasses, may be fitted with emitter devices 214, such that the device may be visible and obvious, and acceptably so, for its “status symbol” value. To allow for a small emitter device 214 size, micro batteries and other power sources may be used to power the emitter devices 214.

Tracking objects 216, such as people, animals, moving, or objects (e.g., cars or balls), may all be fitted with emitter devices 214, but need not be in order to be trackable by tracking device 230 within system 200. As stated above, the emitter devices 214 can be embedded in clothing being worn, props being carried, equipment being used, or fashion accessories being worn. As such, at least one embodiment allows for a tracking object 216 to effectively signal or emit its presence, as it moves about.

In at least one implementation, the typical or expected ways in which a tracking object 216 does move about may be known to the UI system 220, via user configuration or input and embedded system algorithms or software. Thus, as the tracking object 216 moves about, the tracking device 230 can tilt or swivel, or move in 3D space, in order to follow and track the tracking object 216, according to a user's preferences or predefined activity configurations or programmed scripts. As the tracking device 230 thus tracks the tracking object 216, the mounted system 240 and device 242 (be it a camera, light, or microphone), also follows the tracking object 216 in synchronous motion as well as in ways and patterns “predicted” in part by what that the user configures or programs.

The UI system 220 can include a user interface device 222 (such as a smartphone or other computer 12 device), a user interface application (“app”) 224, and a user interface I/O subsystem 226, which enables the UI system to communicate to and from other systems 200 and other devices 210, 220, 230, and 240 within the tracking system 200. In at least one embodiment, the user interface device 222 runs the user interface app 224 and communicates through the user interface I/O subsystem 226, which is typically embedded within and is a part of the user interface device 222. The user interface device 222 provides users with a user interface app 226 that provides an interface to configure one or more emitter devices 214, tracking devices 230, and/or mounted devices 242, and to automate activities within the tracking system 200 via scripts, which are illustrated later. The user interface application 224 may also be programmed to perform other features of sensory input and analysis beneficial to some other system 200, as well as to receiving user tactile input and communicating with the tracking device 230 or the mounting system 240 of the immediate system 200.

Additionally, in at least one embodiment, the user interface app 224 may also allow a user to specifying from a list the kind of activity that a tracking object 216 is participating in (jumping on a trampoline, walking in circles, skiing down a mountain, etc.). In at least one embodiment, the list can be revised and expanded to include additional activities defined by a user or downloaded to the user interface app 224.

The user interface app 224 may additionally allow users to diagram the activities expected by the tracking object 216, define an X and Y grid offset for the tracking of the emitter device 214 by the tracking device 230, specify an offset by which the user wants the action to be “led” or “followed,” etc. (if tracking other than just by centering of the emitter device 214 by the tracking device 230). For example, the tracking device 230 may generally follow the emitter device 214 by biasing the centering of the tracking object 216 in some manner pleasing to the user.

Additionally, the user interface app 224 may additionally enable interpretation, change, or control of the identification signal (or emitted, modulated signal) or the emitter device 214. It may also manage and enable the user interface device 222, and the user interface I/O subsystem 226, to accomplish tasks and processes and methods identified later as useful for other interconnected systems 200.

The user interface app 224 may additionally enable updating of one or more UI devices 222, tracking devices 230, mounting systems 240, emitter systems 210, or other computers connected to the tracking system 200. Additionally, the user interface app 224 may provide for execution of unique and novel formulas or algorithms or scripts or configuration data, enabling improved functioning of the tracking device 230 or other systems within the tracking system 200. For example, a user may be able to download a particular script that is directed towards tracking basketball players or a script that is directed towards tracking scuba divers. Accordingly, at least one embodiment of the present invention provides significant flexibility in tracking a variety of different activities.

Turning now to the tracking device 230, the tracking device 230 may include one or more sensory subsystems 232, control subsystems 234, and positioning subsystems 236. The sensory subsystem 232 may be comprised of one or more sensors or receivers including infrared, RF, ultrasonic, photographic, sonar, thermal, image sensors, gyroscopes, digital compasses, accelerometers, etc. In at least one embodiment, the sensory subsystem 232 includes an image sensor that reacts to infrared light that is emitted by one or more emitter devices 214. The sensory subsystem 232 may be designed specifically to identify more than one emitter device 214 simultaneously. The sensory subsystem 232 may be capable of identifying multiple emitter devices 214 that are of the same signal or modulation or pulse rate, or of different signals or modulations or pulse rates.

In at least one embodiment, if multiple emitter devices 214 are of the same signal, modulation, or pulse rate, they may be perceived by the sensory subsystem 232 as a single light source (by means of a weighted average of each, or by some other means), although in fact they may combine to represent a single “point cloud” with multiple, similar signals, modulations, or pulse rates. Similarly, in at least one implementation, if multiple emitter devices 214 are of different signals, modulations, or pulse rates, they may be perceived by the sensory subsystem 232 as distinct from each other—creating in effect, multiple light sources within the perception of the sensory subsystem 232. Each light source perceived by the sensory subsystem 232 may be converted to an X and Y position on a two-dimensional grid, as in a Cartesian coordinate system, by the sensory subsystem 232 and/or control subsystem 234. In at least one implementation, each light source can be positioned within a three-dimensional grid, comprising X, Y, and Z coordinates based upon relative position and distance from the tracking device 230.

The two dimensional grid may be understood as an image sensor onto which light is focused by lenses, as in a camera system, of which the sensory subsystem 232 may be a kind. The image sensor may be a two-dimensional plane, which is divided by units of measurement X in its horizontal axis, and Y on its vertical axis, thus becoming a kind of measurement grid.

Several times per second (perhaps 24, 30, or 60 or a particular video frame rate), the location of each unique emitter device 214 (based upon a unique signal or modulation, or pulse rate, or perhaps some other identifiable marker), or of each “point cloud” represented by a group of similar emitter devices 214 (based upon a unique signal or modulation, or pulse rate, or perhaps some other identifiable marker), may be given an X and Y coordinate representation, which may be represented as two integer numbers.

In at least one embodiment, the tracking device 230 uses the X and Y coordinate data to calculate (via the control subsystem 234) a distance from a center X and Y position, in order to then position tilt- and swivel-motors via a positioning subsystem 236 to “center” (or bias-center) the emitter device 214 within its two-dimensional grid. The net effect is that the tracking device 230 tilts and swivels until “facing” the emitter device 214, or emitter device 214 “point cloud.”

Additionally, in at least one embodiment, several times per second the tracking device 230, identifies an X and Y coordinate for each emitter device 214, or “point cloud” of emitter devices 214. These X and Y coordinates may be saved as a history of coordinates (perhaps appended to a data array unique to each emitter device 214 or emitter device 214 cloud) by the control subsystem 234. Over time, these data arrays represent a history of travel of the emitter device 214 or cloud. These data arrays can then analyzed by a control subsystem 234, possibly based upon configuration data that may come from the UI system 220, in order to “fit” their data history into mathematical curves or vectors that approximate the array data history of travel, and also “predict” X and Y coordinates of future travel. In this manner (and in similar ways) the tracking device 230 may thus obtain and analyze data whereby it might “learn” how to better track the tracking object 216 and the emitter device 214 over time or in similar situations in the future.

Accordingly, in at least one implementation, the control subsystem 234 may control a positioning subsystem 236, and its tilt and swivel motors, in a partly “predictive” manner, that “faces” the tracking device 230 at the current or predicted location of the emitter device 214 or cloud over time. This may be particularly useful in cases where the emitter device 214 is partly or fully obscured for at least a period of time. The net effect of a “learning” and “predictive” tracking capability may yield a more “responsive” and “smooth” tracking activity than would be the case with the simple embodiment or tracking/centering approach alone. The control system 234 may employ other unique and novel mechanisms to smooth the tilt and swivel motors of the positioning subsystem 236 as well, including using unique mathematical formulas and other data gathered via I/O subsystems 246, 226, 212 or those of other tracking systems 200. Triangulation of emitter devices 214 and related tracking device 230 control may thus be enabled.

In at least one implementation, the positioning subsystem 236 responds to controls from the control subsystem 234 to control servo motors or other motors, in order to drive rotation of the device on a tilt axis, rotation on a swivel axis, and perhaps rotation on a third axis as well.

Additionally, in at least one implementation, the mounting system 240 includes a mounted device 242 (such as a light, camera, microphone, etc.), an attachment adapter 244 (which enables different devices to be adapted for mounting quickly and easily), and a device I/O subsystem 246. In at least one embodiment, the device I/O subsystem 246 enables communication and control of the mounted device 242 via a tracking device 230, UI system 220, or emitter I/O subsystem 212, or some combination of these, including other systems and subsystems of other tracking systems 200. Data from the mounted device 242 may also be provided to the tracking device 230, the UI system 220, and/or the emitter system 210 in order that system 200 performance may be improved thereby in part.

The mounted device 242 may be affixed via the attachment adapter 244 to the tracking device 230, such that the mounted device 242 may be tilted or swiveled in parallel with the tracking device 230, thus always facing the same direction as the tracking device 230. Additionally, the mounted device 242 may be controlled via the device I/O subsystem 246 (and perhaps also via the UI system 220 or the tracking device 230), in order to operate the mounted device 242 simultaneous to the mounted device 242 being positioned by the tracking device 230.

The tracking device 230 is sometimes referred to simply as “tracker.” An emitter device 214 is sometimes referred to as simply as “emitter.” The emitter I/O subsystem 212 may be called an “emitter,” the subsystem 212 with the emitter device 214 together or collectively are sometimes called “the emitter” 215. The user interface device 222 is sometimes referred to as simply the “user interface.” The sensory subsystem 232 is sometimes referred to as “detector.” The control subsystem 234 is sometimes referred to as “controller.” The positioning subsystem 234 is sometimes referred to as “positioner.” The device I/O subsystem 246 is sometimes called the “mount I/O system.” The mounting system 240 is sometimes called a “mount system.” The attachment adapter 244 is sometimes called an “adapter.”

Processes associated with system 100 and system 200 include, but are not limited to, the following: making decisions about whether or not to track; knowing what algorithms to use for tracking of an emitter or tracking object; sensing of an emitter by a tracker; sensing of a tracking object by a tracker; plotting the position of an emitter or tracking object within a space or coordinate system of the tracker; saving history of plotting or sensing or motor encoder, or other information; configuring which emitter or emitters or tracking object or tracking objects to track and under what circumstances to aim or follow or track; predicting where one or more emitters or tracking objects may be going in the future; smoothing the predicted path of the emitters or tracking objects or motors moving to aim at emitters or tracking objects, all in accordance with knowing and configuring data; positioning of the motors (while optionally using encoder information from the motors) via rotating them in positive or negative amounts or degrees or encoder “ticks.”

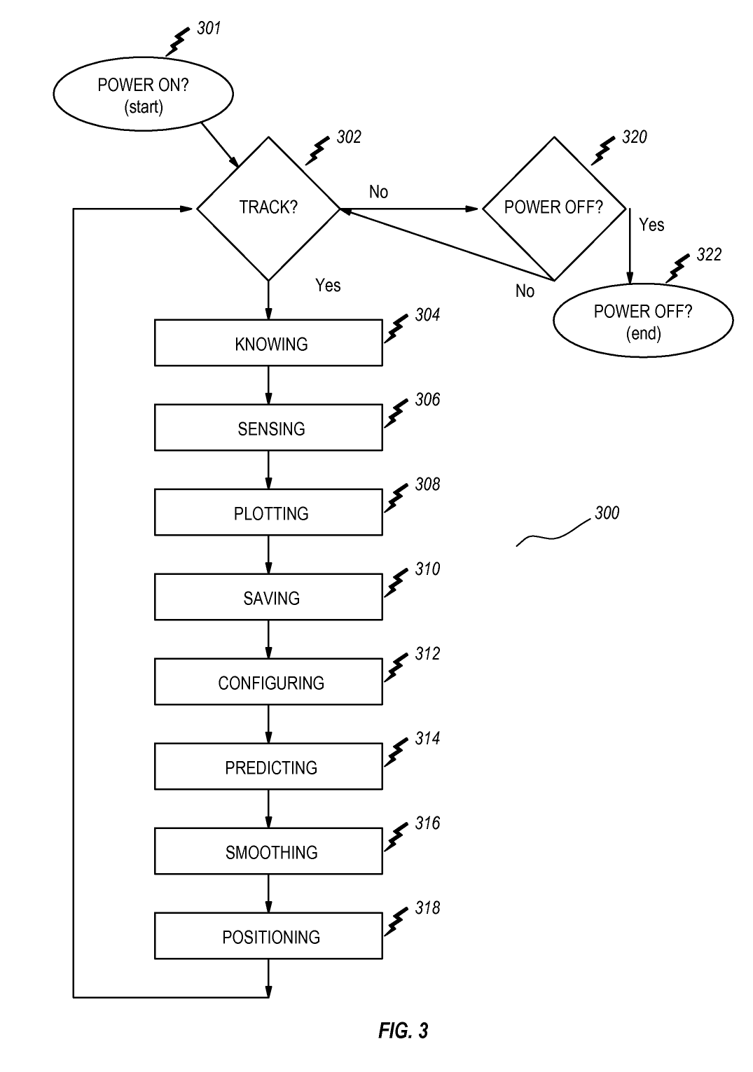

FIG. 3 depicts a block diagram of an implementation of a method 300 for enabling the control system 234 to properly affect the positioning subsystem 236 via data gathered from the sensory subsystem 232, and the UI system 220, and perhaps the mounting system 240 as well as from other tracking systems 200. In a preferred embodiment, process 300 may be contained within software within memory, or in whole or in part within an FPGA device designed for this purpose. Thus system 300 may be embodied in software or hardware, and may include one or more buttons or switches, and computers (or parts thereof), and logic boards, and software programs. In a preferred embodiment, system 300 resides within the control system 234, but it might reside in whole or in part in the UI device 222, the mounted device 242, or the emitter device 214, or in other devices or system of other somehow interconnected systems 200.

Labeled items 301, 302, 304, etc. may be thought of as tasks that are executed via user input, or by system function, or partly via programmable scripts, in order to achieve the overall process or logic flow required by the present invention. Portions of method 300 may be represented with one or more modules or devices. For example, a button or similar switch or device 301 is used to power on the tracking device 230, and enables the process defined in method or system 300. If button 301 has been depressed properly, the tracking device 230 is in a state of “being powered on.” After the power is switched on, a user may determine if the process is actually to begin, by (optionally) answering the question of whether or not he/she is ready to track (302). Alternatively, question 302 (as well as other questions of system or method 300) may be answered by the system or by a user configuration setting, or pre-programmed script.□

In a preferred embodiment, a button is used to power on 301 the tracking device 230, and which also commences “automatically configuring” the tracking device 230 to the pulse modulation mode of the present or closest emitter 214. If button 301 is immediately pressed again, the emitter modulation mode may be incremented to a next appropriate mode, thereby enabling the tracking system 230 to track only emitters 214 configured to this next modulation mode. In any case, after button 301 is pressed, the tracking device may shortly thereafter begin tracking automatically an emitter with the selected or configured modulation mode. There may also be visual LED prompts that aid the user in these activities, as well as to help the user readily identify the state that the tracking device 230 is in relative to process 300.

By answering Yes to the tracking question 302, and if it hasn't already thus changed, the tracking device 230 can be switched into a state of “tracking” and can begin (if it hasn't already done so) the task of learning or knowing 304 what kind of emitter device 214, or emitter device 214 cloud (of similar modulation, pulse rates, or signals) it is to track. Not withstanding the tracking device 230 may sense multiple different emitter devices 214 or clouds at any given time, it is generally going to be configured to follow a single emitter device 214 or cloud at a given time.

The task of knowing 304 is the system task of checking a variable, within a system (perhaps a software or hardware or similar system) embedded in the control system 234 (which may be a computer, or parts thereof), which stores the name or identifying ID of the target emitter device 214 or cloud. Thus knowing 304 enables the tracking device 230 to begin searching for or sensing 306, the unique modulation/signaling/pulsing ID associated with the proper emitter device 214 or cloud. This act of “knowing” may be initiated by pressing the button 301 at or near the act of powering on the device 230, as discussed previously, or it may be accomplished by a user pressing this same button 301—or via some other method using the UI system 220, or some other method—during a tracking activity, as might be the case if the user decides to switch the modulation modes and thus to track a different emitter 214.

For example, LEDs on the emitter may visibly emit a particular pattern that a user can match with a corresponding pattern visibly emitted by indicator LEDs on the tracker. In particular, the user can cycle through a series of LED patterns on the tracker and/or the emitter until finding a desired matching pattern. Alternatively, in at least one implementation, each emitter and/or tracker is associated with a particular designation (e.g., a name, a serial number, etc.). A user can enter, or otherwise select, the designation on either the emitter or the tracker, and thus program the tracker to follow the desired emitter.

Task 306, sensing the emitter device 214, shall none-the-less include the sensing of other emitter devices 214 or 215 or clouds, and may include the identifying or plotting 308 of the X and Y coordinate position of one or more unique emitter devices 214 or clouds. The task of saving 310 is the storing of each coordinate position, by emitter device 214 or cloud, into a data array variable within the system (perhaps a software or hardware or similar system) that resides within the control system 234. It includes other saving functions, where other system 300 related data is saved. This task is performed, as are all of the other tasks in 300, multiple times per second (although some tasks may be bypassed or become optional by some alternative method 300 or by user configuration or programmed script). Thus each cycle through the process illustrated in 300 results in each task being performed or bypassed, as illustrated in part by the diagram 300.

Thus the tasks of sensing 306, plotting 308, and saving 310, each happen several times per second, and thus record, over time, the position of each emitter device 214, and the position changes over time. Although configuring can happen via the UI system 220, and otherwise, and its data be used in method 300 prior to 312, configuring 312 is the task of retrieving and analyzing data variables from memory by a processor (or via a hardware only process, as by FPGA) residing within the control system 234, which may have originated from the UI system 220. This configuration data that is checked in the configuring task 312, may include mathematical curves, or vectors, programmed scripts for automating system 200 activities, as well as other configuration data specific to the emitter device 214 or cloud, or other components of the tracking system 200.

In at least one embodiment, the configuration data may be a mathematical curve or vector associated with the kind of tracking object 216 activity anticipated by the user, and configured via an UI system 220, thus enabling the predicting task 314 of the process, particularly if the emitter device 214 is not visible wholly or for a period of time. A user may interact with a UI system 220, independently from the configuration task 312. Once the UI system 220 data is transferred (perhaps via the user interface I/O subsystem 226) to the control subsystem 234, the data may become accessible to the algorithms and methods associated with the configuration task 312, and to future cycles through the process 300. In this manner, and perhaps others, method steps 304, 306, 308, and 310 may all have access to configuration 312 data even though configuring 312 follows these other steps in method 300.

The predicting task 314 includes application of novel and unique algorithms, which may serve purposes of fitting or averaging the plotting data from task 308, with curves identified by users and configured in task 312. This process or similar processes of “averaging” of data types, can also serve to smooth 316 the data passed to the positioning system 318, in such a way that the effect is a more “professional” or less choppy motion (as “seen” or recorded by the mounted video device 242 or another device 242). Additionally the predicting task 314 may assist in analyzing some or all of the history of past emitter 214 location X, Y data, “learning” from that analysis, and making and storing assumptions as a results, which help to yield positioning data (similar to data of the type found in task 308) related to where the emitter tracking object 216 will likely move next.

Such predictions may also include ranges of data, intermediate sums or products, and statistical standard deviations, and so on. Such predictions of tracking object 216 movements, will be used to aid the responsiveness of the system to such movements, and will include additional, novel and unique methods to insure that predictions are combined with (and rank-ordered as subordinate to or superior to) simple plotting task 308 data, in order to insure both responsiveness and accuracy.

The smoothing function 316 assists “responsiveness” by enabling corrections or overcorrections to be integrated back into the positioning 318 function minimizing unacceptable results for users. Additionally, predicting task 314 processes may derive from or be combined with both configuration data in the form of algorithms, based on mathematical smoothing functions, in order to affect the commands of the control system 234, and also user-programmable scripts that affect predicting 314, smoothing 316, positioning 318, and other methods of 300 and of the tracking system 200. The net result of system 300 functioning, is that the tracking device 230 moves in a manner that the mounted device 242 (such as a camera) may record footage that is more aesthetically pleasing, and otherwise more typical of footage shot by a seasoned professional cinematographer or camera operator, rather than footage shot by a machine.

After the smoothing task 316 is completed, the positioning task 318 can be executed, which may include all of the processes executed by the positioning subsystem 236. Thus the motor system is controlled on both a tilt and swivel basis, in order to track a tracking object 216, or otherwise behave in a manner that may be stipulated by the user-programmable script. Once a positioning task 318 is completed, the process returns to the question of whether or not to continue tracking 302. In at least one implementation, the answer is presumed to be Yes, after the initial loop thru process 300, unless, and until, the user presses a button (shared with task 301) or otherwise indicates to the tracking device 230 via UI system 220 or user-definable script that a pause in the process is desired, which results in the tracking question 302 being answered with No.□

If the tracking question is Yes, the tasks of 304 through 318 are executed again, and return to task 302, over and over again (in an operating state or a tracking state) until interrupted by a No response to the tracking question 302. If the tracking question 302 is No, a second question 320 is asked, should the system power off? If the answer to that question 320 is also No, then the tracking device 230 is in “paused state” of readiness, unless and until the tracking question 302 is answered by Yes (via a button push or other method), or the power off question 320 is answered by Yes and the power off 322 task is executed. The “pause state” may also, in a preferred embodiment, be the result of holding down the same button 301 for a longer duration than would be the case of powering on or incrementing thru emitter modulation modes. The “power off” 320 question may similarly be answered by the same button 301 being depressed for a longer duration still. If the power off 322 task is executed then the tracking device 230 is in a state of “being powered off”

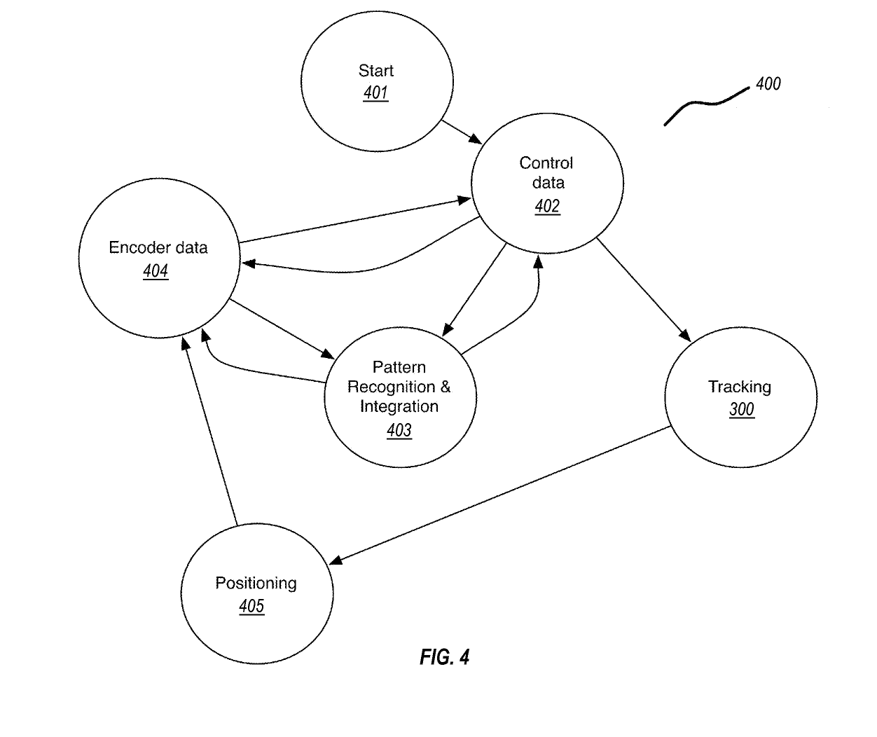

FIG. 4 depicts a block diagram of an implementation of a method 400 for integrating data for pattern recognition, and for integrating recognition-data results in order to improve tracking and positioning. The tracking process is shown to start 401, where control data 402 is obtained by the control subsystem 234 which may include data from any sources or sensors of system 200, including RF phase-shift data, image-sensor x and y coordinate data or image data, accelerometer data, altimeter data, GPS data, and so on.

In at least one implementation, encoder data 404 comes from the positioning subsystem 236 motor or gear movements, or from any other encoders of system 200. This data is integrated with control data 402 by a control subsystem 232. Both control data 402 and encoder data 404 may be known to a pattern recognition and integration system 403, which (1) searches for patterns in tracker 230 movements via algorithms in memory within system 200 and processed by processors of system 200; (2) predicts where the tracker will likely move next; and (3) shares or makes those predictions available to the tracking method 300 for integration into the activities or processes of system 300.

Positioning of the motors 405 may be controlled via the motor control subsystem 234 with the aid of data from the tracking system 300, and in turn generates or facilitates data for use by the encoder data subsystem 404. Several activities of method 400 may both receive data from other activities (such as control data 402 from encoder data 404) and provide data back to the other activities (as illustrated by arrows in both directions between them).

If a tracking object 216 is jumping on a trampoline, the pattern recognition & integration module 403 may receive data resulting from those activities including encoder data 404 and control data 402 in order to identify how frequently the jumping is occurring, how “high” the jumping typically goes, how “low” the jumping typically goes, and how far left or right the tracking object 216 typically strays. Mathematical points and curves representing a tracker's encoder data 404 or control data 402 can be plotted and/or analyzed using commonly understood mathematical and statistical formulas and algorithms in software with a processor, or via a programmed FPGA, or by some other device or method associated with the tracker 230 or subsystem of tracking system 200.

Such data can then be used to predict 403 what future encoder data 404 and control data 402 is likely to see in the immediate future, and hence can be used to provide data input into the tracking 300 method in order to provide positioning 405 of the motors in ways that are more predictive. This can be particularly helpful if periodically on the trampoline a tracking object 216's emitter 215 is temporarily obscured. It can also be helpful if one wishes to “bias” the framing of the tracking object 216 to “lead the action” as a cinematographer may choose to do.

The tracker may be made to similarly find patterns 402 and thus better anticipate action and “bias” framing, and perform other useful tracking 300 when observing many other common activities, for example, a tracking object 216 involved in speed skating around a rink, biking around a track, running around a track, diving off of a diving board, racing in a car, running past a finish line, etc.

In at least one implementation, the tracker may be designed to perform this pattern recognition automatically or manually. For example, a user can specifically configure the tracker to look for a pattern in an activity. As another example, a user can select a pre-existing pattern from a list of optional selections either in the tracker 230 or a UI system 220 or another subsystem of system 200 and requests that tracker 230 implements or integrates 402 the pattern via systems 400 and system 300.

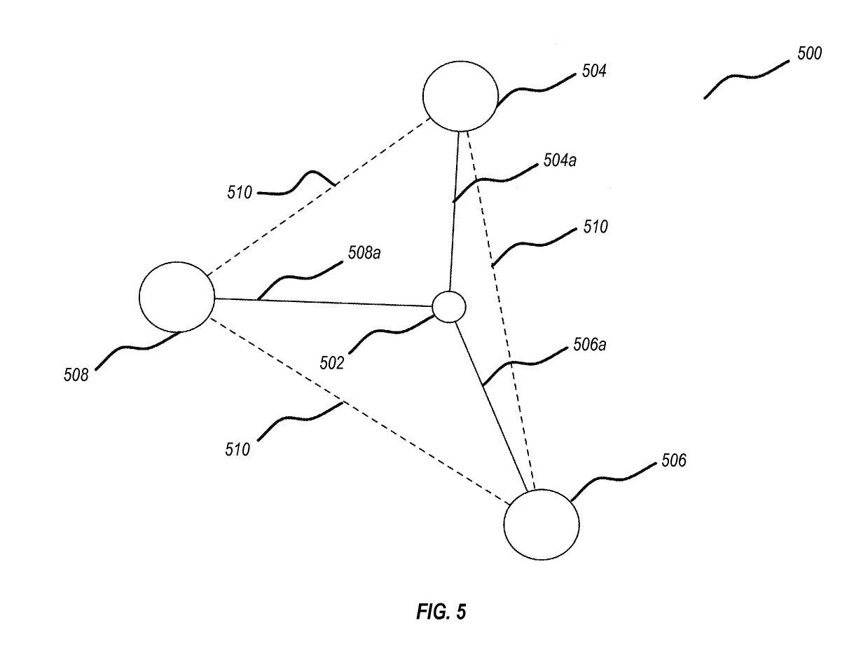

Turning now to FIG. 5, FIG. 5 depicts a schematic illustration of an implementation of an emitter 215 (numbered here as 502) or tracking object 216 (numbered here also as 502) being tracked by three tracking devices 230 (numbered as 504, 506, 508) which are communicably interconnected (510) in ways that enhance the tracking of each tracking object. In particular, diagram 500 is a top view illustration of trackers 504, 506, 508 and emitter or tracking object 502. Tracker 504 is shown sensing a signal or line-of-site 504a to emitter 502 or tracking object 502. Tracker 506 is sensing emitter 502 as shown by 506a, and tracker 508 is sensing emitter 502 or object 502 as illustrated by 508a.

In at least one implementation, it can be assumed that trackers 508, 504, and 506 include sensor subsystems 232 that include or are interconnected with accelerometers, gyroscopes, altimeters, ultrasonic emitters and sensors, GPS modules, I/O modules, processors, memory, and one or more digital compasses. Additionally, the emitter 502 or the object 502 may or may not include or be attached with or associated with one or more accelerometers, gyroscopes, altimeters, ultrasonic emitters and sensors, GPS modules, I/O modules, processors, memory, digital compasses.

Each tracker 504, 506, and 508 can be made to sense its respective distance from other trackers 504, 506, and 508 by means of a GPS module or by certain processes other methods. For example, the trackers 504, 506, 508 may determine each other's respective positions through distance finding measurements, radar measurements, sonar measures, laser measurements, user input, and other related methods.

Furthermore, each tracker 504, 506, and 508 can be made to sense their orientation. For example, the trackers 504, 506, 508 can rely upon integrated digital compasses and/or gyroscopes to determine current orientation. Additionally, each tracker 504, 506, 508 can transmit or share position information, via RF transceivers or IR sensors and receptors or sonar sensors and emitters—and can also share other information related to its motor/gear encoders from its positioning subsystem 236, including the angle or tilting or swiveling to center an emitter 502 or object 502 and to track it according to system 300.

In at least one implementation, all pattern recognition & integration 403 data associated with system 400 is accessible to each tracker and to the emitter of system 500. And the encoder data referred to in system 400 can be used to determine angular rotations of each tracker 230. Furthermore, when a tracker is seeing the emitter 215 it can indicate so or broadcast that information to the other trackers, and when not tracking, the tracker 230 can transmit that data. Thus each tracker can know which other trackers 230 can “see” the emitter 215 and what their encoder data/angular rotations are on a tilt and swivel basis.

Accordingly, in at least one implementation, each of the trackers 504, 506, 508 can track the object 502 using trigonometry and information received from the other respective trackers 504, 506, 508. For example, tracker 504 can track the object 502, even if the object 502 is not visible to tracker 504 based upon information received from trackers 508 and 506 and based upon knowledge of the relative positions of trackers 508 and 506. For instance, tracker 504 may receive information indicating the distance that the object 502 is from each respective tracker 506, 508 and the angle at which the object is from each respective tracker 506, 508. Using this information, the tracker 504 can orient towards the object 502, even if the object is not directly visible to tracker 504. While system 500 shows only three trackers 504, 506, 508, it might include more than three and use similar methods to triangulate from other trackers 230.

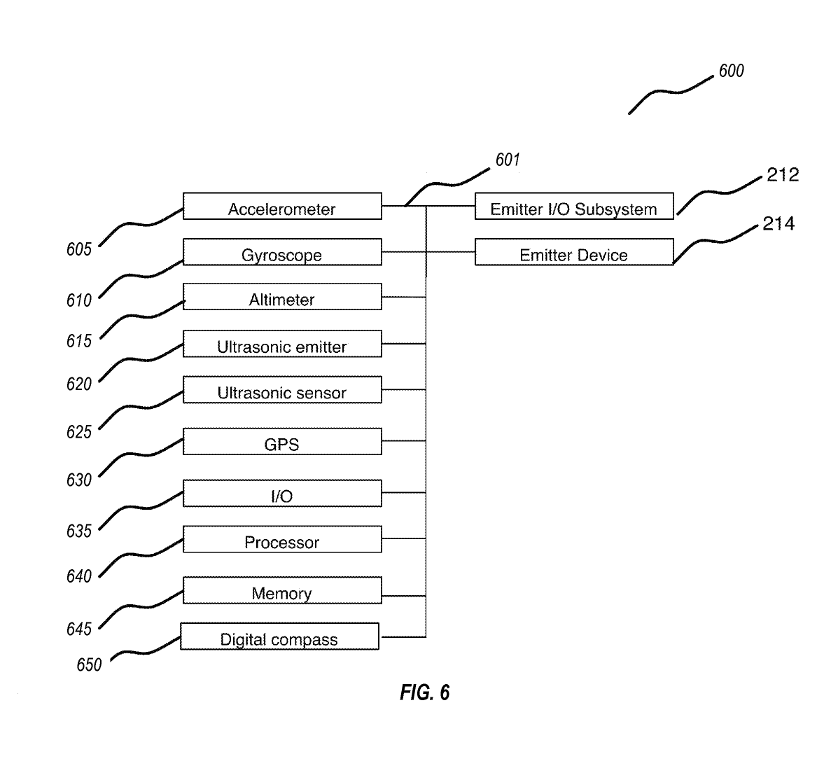

In addition to multiple trackers, in at least one implementation, the tracking system can comprise supplemental emitters (“beacons”). For example, FIG. 6 depicts a block diagram of an implementation of a supplemental emitter 600, functionally interconnected with a primary beacon 215 (212 and 214). The bus or connector 601 may be physical or wireless. The supplemental emitter 600 may be comprised of all components shown or only some of them. In at least one implementation, the emitter I/O subsystem 212 and emitter device 214 may or may not be a part of the supplemental emitter 600 but are shown here to indicate a likely digital connection for communication and control via a bus or other means 601.

Various different modules can provide information within the supplemental emitter 600. For example, an accelerometer 605 module can provide x, y, and z axis data related to acceleration of the emitter 600 and of the tracking object 216 that emitter 600 may be associated with. Additionally, a gyroscope module 610 can provide rotational data related to the emitter 600 and of the tracking object 216 that emitter 600 may be associated with. Similarly, an altimeter module 615 may provide altitude or height data related to the supplemental emitter 600 and of the tracking object 216 that emitter 600 may be associated with.

In addition, an ultrasonic emitter module 620 may provide ultrasonic sound or “pings” related to the emitter 600 and of the tracking object 216 that emitter 600 may be associated with. Similarly, an ultrasonic sensor module 625 can sense ultrasonic sound or “pings.” A GPS module 630 can identify the location of the emitter 600 and of the tracking object 216 that emitter 600 may be associated with. Additionally, a digital compass 650 can be used to obtain data indicating the direction in which supplemental emitter 600 may be facing or moving.

In at least one implementation, an I/O module 635 can provide for wireless, Bluetooth or other communication to and from other devices (and may include an RF transmitter or receiver or transceiver) enabling sensory data from the emitter 600 to be sent to the tracker 230 (or 600) and also to receive data from the same. Processor 640 may comprise a microprocessor or controller for digital computing of sensory data from the supplemental emitter 600 and elsewhere of system 200, and memory 645 is memory used by the processor and perhaps other components of 600.

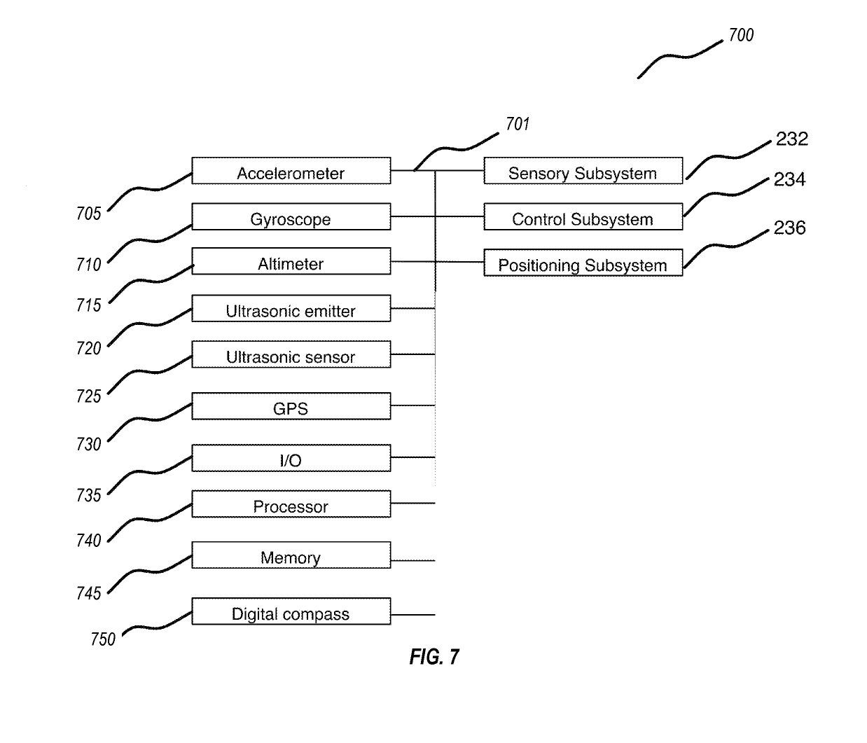

FIG. 7 depicts a block diagram of an implementation of a supplemental tracker 700 functionally interconnected with a primary tracker 230. The bus or connector 701 may be physical or wireless. And the device may be comprised of all components shown or only some of them. The sensory subsystem 232 and the control subsystem 234 and the positioning subsystem 236 may or may not be a part of the supplemental tracker 700 but are shown here to indicate a likely digital connection for communication and control via a bus or other means 701.

Various different modules can provide information within the supplemental emitter 700. For example, an accelerometer module 705 can provide x, y, and z axis data related to acceleration of the emitter 700 and of the tracking object 216 that emitter 700 may be associated with. Additionally, a gyroscope module 710 can provide rotational data related to the emitter 700 and of the tracking object 216 that emitter 700 may be associated with. Similarly, an altimeter module 715 may provide altitude or height data related to the supplemental emitter 700 and of the tracking object 216 that emitter 700 may be associated with.

In addition, an ultrasonic emitter module 720 may provide ultrasonic sound or “pings” related to the emitter 700 and of the tracking object 216 that emitter 700 may be associated with. Similarly, an ultrasonic sensor module 725 can sense ultrasonic sound or “pings.” A GPS module 730 can identify the location of the emitter 700 and of the tracking object 216 that emitter 700 may be associated with. Additionally, a digital compass 750 can be used to obtain data indicating the direction in which supplemental emitter 700 may be facing or moving.

In at least one implementation, an I/O module 735 can provide for wireless, Bluetooth or other communication to and from other devices (and may include an RF transmitter or receiver or transceiver) enabling sensory data from the emitter 700 to be sent to the tracker 230 (or 700) and also to receive data from the same. Processor 740 may comprise a microprocessor or controller for digital computing of sensory data from the supplemental emitter 700 and elsewhere of system 200, and memory 745 is memory used by the processor and perhaps other components of 700.

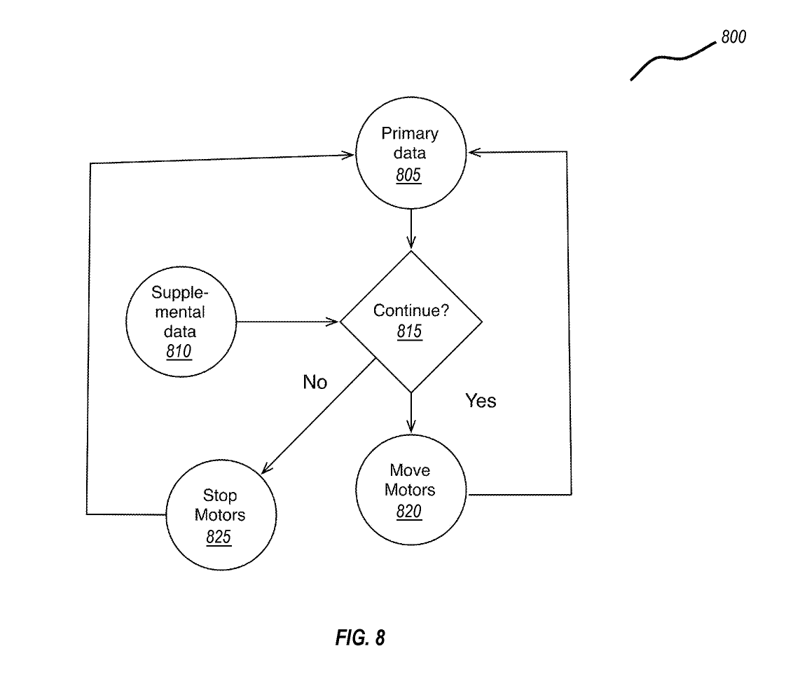

FIG. 8 depicts a block diagram of an implementation of a method 800 for integrating primary data 805 from a main beacon or emitter 215 and tracker 230, with supplemental data 810 from a supplemental emitter 600 and a supplemental tracker 700. In particular, decision 815 to continue tracking may be made by the processor 740 or 840 and algorithms stored in memory 745, 845. Primary data 805 and supplemental data 810 are used by the algorithms for such computations and decisions. Activities to stop the tracker 230 motors 825 are done via positioning subsystem 236. Activities to move the motors 820 are done via positioning subsystem 236.

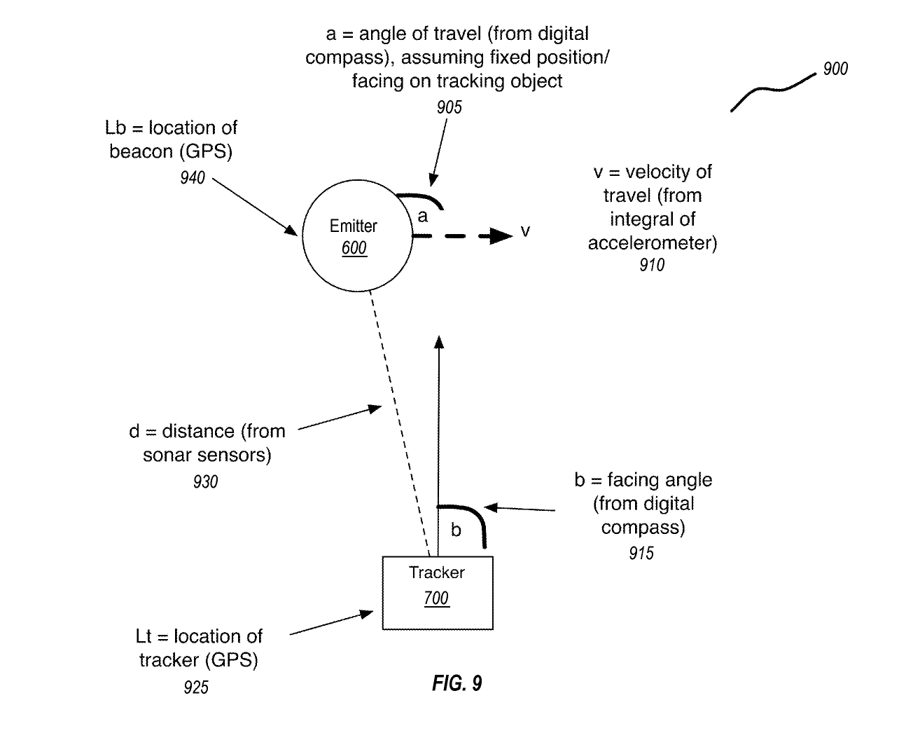

FIG. 9 depicts a schematic diagram showing an implementation of how sensor data may be used to determine swivel information for the tracker 700 and supplemental emitter 600. The location of the emitter 600 is indicated by 940 and derives from the emitter 600 GPS module. The location of the tracker 700 is indicated by 725 and derives from the tracker 700 GPS module. The distance between the tracker 700 and the emitter 600 is indicated by 930 and may derive from sonar sensors of the tracker 700 and the emitter 600 or from GPS sensors from both.

The facing angle of the tracker 700 is indicated by 915 and is obtained from a digital compass of the tracker 700. The angle of travel of the emitter 600 is indicated by 905 and is obtained from a digital compass of the emitter 600. Similarly, the velocity 910 of the emitter 700 is indicated, and derives from the mathematical integral of the accelerometer module of the emitter 700.

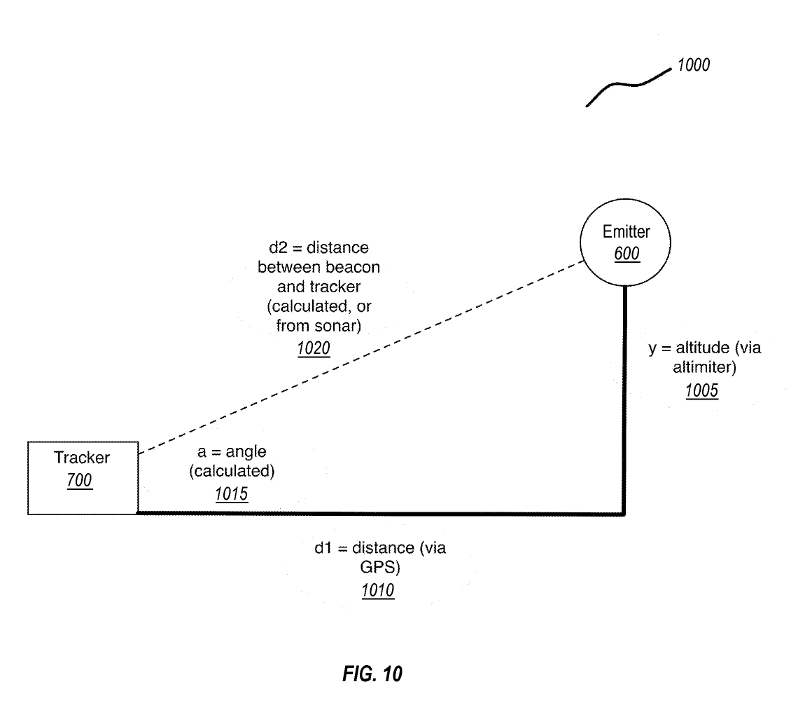

FIG. 10 depicts a schematic diagram 1000 illustrating an implementation of how sensory data may be used to determine tilt information for a tracker 700 and how data related to a 3^{rd} axis of rotation might also be used by a tracker 700 to determine angular rotation around that 3^{rd} axis as well. As depicted, the distance, shown from a top view perspective, between the tracker 700 and the beacon 600 can be obtained from GPS data 1010 (via modules within the tracker 700 and beacon 600).

The altitude 1005 of the emitter 600 is indicated, and can be derived by taking the absolute value of the difference between the data from the two GPS modules (the tracker 700 and emitter 600.) The distance between the tracker 700 and the emitter 600 can be obtained by sonar modules within each, as indicated 1020. From this data, an angle 1015 can be calculated for tilting the tracker 700 to point at the beacon 600.

Below we will describe how components of the previous figures can be used (in part, and in a non-limiting way) to realize various embodiments and benefits of the invention. For example, a supplemental emitter 600 may be used in conjunction with (or made to be a part of) a primary beacon or emitter 215. Where a primary beacon 215 may provide most data for detection/sensing/receiving by a tracker, the supplemental emitter 600 may augment such data to provide better tracking results in circumstances where there is limited line-of-site data or when supplemental data may otherwise be useful. Similarly, a supplemental tracker 700 may be used in conjunction with a main tracker (and may be embedded within or made a part of a main tracker) 230, and provides additional sensory data and other functionality required to communicate with and receive and interpret data from the supplemental emitter 600.

If a tracking object 216 has a supplemental emitter 600 (an associated or integrated emitter 215), which is in communication with a supplemental tracker 700 (and an associated or integrated tracker 230), then supplementary data can be used by the tracker 230 to more accurately aim at a tracking object 216. The data coming from one or more emitters 215 and one or more trackers 230, sensed by the sensory subsystem 232, and analyzed by the control subsystem 234, in order to control the positioning subsystem 236 can me known as primary data.

In various implementations the use of a supplemental emitter 600 and supplemental tracker 700 along with an emitter 215 and a tracker 230 may provide unique and important benefits. For example, one problem that a tracking system may have is when an emitter 215 or beacon goes behind a fence or other obstruction, and so the primary tracking technology (infra-red emitter/sensor which requires direct line-of-site, for example) may no longer provide continuous data that can be acted upon by the sensor subsystem 232 or control subsystem 234. Understandably, it can be difficult or impossible to determine whether a tracker 230 continues along its previous path in such a case, or simply comes to a stop. Any additional information that may assist this decision can be valuable and useful.

In at least one implementation, a supplemental emitter 600 and supplemental tracker 700 can overcome this problem. In particular, data from a supplemental emitter 600 accelerometer 605 may be transmitted via Wi-Fi, Bluetooth, or another means via I/O 635 to a supplemental tracker 700 and be received/sensed by its I/O 735 module. Accordingly, if the accelerometer 605 data thus sent by I/O 635 and thus received by I/O module 735 shows that the tracking object 216 (and associated emitter 215 and supplemental emitter 600) has sharply decelerated, then a tracker 230 algorithm stored in memory and processed can make a decision to stop tilting or swiveling along the previous path.

In other words, primary data from the emitter 215 and tracker 230 is supplemented with supplemental data (accelerometer 605 data) to determine if tracking should continue as before. If the accelerometer 605 data shows a sharp deceleration, the system algorithm stored in memory and processed by processor may stop motors (and tracking) until more primary data or supplementary data is available to analyze.

In at least one implementation, if primary data is no longer available, and supplemental data (accelerometer 605) shows that no deceleration has occurred, then a tracker 230 algorithm stored in memory and processed by processor can make a decision to continue tilting or swiveling along the previous path. Accordingly, implementations of the present invention provide methods and systems for using supplementary emitters 600 to improve the tracking of an object in various circumstances.

In an addition example, assume that the tracking object 216 with the associated emitter 215 and beacon 600 are going up or down. Assume that the primary data becomes obstructed. If the supplemental data (including altimeter 615 data) available via I/O module 635 to the supplemental tracker 700 data indicates that altitude is still going up or down as before, then an algorithm stored in memory and processed by processor may cause the motors to continue moving (tilting) up or down as before. In contrast, in at least one implementation, if a gyroscope 610 on a beacon 600 shows a 90 degree (approximate) rotation, and a sudden deceleration, then the algorithm in the control subsystem 234 might assume that a person has fallen, and thus that a decision to stop the motors is reasonable.

In a further example, assume that the tracking object 216 with the associated emitter 215 and beacon 600 are going up or down. Assume that the primary data becomes obstructed. If the supplemental data (including altimeter 615 data) available via I/O module 635 to the supplemental tracker 700 data indicates that altitude has stopped, then an algorithm stored in memory and processed by processor may cause the motors to stop moving (tilting) up or down.

Additionally, in at least one implementation, assume that the tracking object 216 with the associated emitter 215 and beacon 600 rotating around. Assume that the primary data becomes obstructed at times during that rotation when there is not a direct line-of-site between the emitter 215 and the tracker 230. If the supplemental data (including digital compass 637 data) available via I/O module 635 to the supplemental tracker 700 or supplemental data and indicates that rotation is still occurring as before, then an algorithm stored in memory and processed by processor may stop the motors from moving or rotating (moving) until the primary data.

Further, in at least one implementation, assume that the tracking object 216 with the associated emitter 215 and beacon 600 is based upon an RF phase-shift detection tracking technology. Assume that the emitter 215 is so close to the ground, and so far away from the tracker 230 that the primary data becomes confused with multi-path interference at times during tracking, such that primary data includes reflections and other “false” positive multi-path interference. In such a case, altitude of emitter 216 may be difficult to determine from the primary data alone. In this or similar cases, if the supplemental data (including altimeter 615 data) available via I/O module 635 to the supplemental tracker 700 indicates what the actual altitude is (or how much it has changed), then an algorithm stored in memory and processed by processor may continue moving (tilting) until the primary data can be seen free of multi-path interference, which might be determined by alignment with the altimeter 615 data or supplemental data. Similarly, altimeter 615 data can be used as supplemental data to help a process and algorithm stored in memory determine if motors should be stopped.

In the case of the above scenarios, other supplementary data may also be useful in determining when to stop and when to continue the tracking paths, such that combining more than one type of supplemental data may yield even more accurate and useful decisions. Similarly, supplemental data from the beacon 600 and the tracker 700 can be used on conjunction to determine information such as relative height, relative velocity/direction of travel, relative angle of facing on a compass. Together this information can enrich the available data and provide for new tracking approaches.

Additionally, in at least one implementation, battery conservation considerations can be used to determine what sensors and data to use. For example, in at least one implementation, a GPS module may take significantly more power than approximating a location by a line method. Accordingly, the system may deactivate that GPS module and rely upon the line of sight measurement tools—until the line of sight measurement tools are no longer sufficient.

Regardless of the primary tracking technology being used, supplementary data might be used to add another layer of data useful to tracking control by the tracker 230. A supplemental beacon 600 and supplemental tracker 700 can provide either supplemental data or primary tracking data by providing swiveling and tilting data.

The combination of various supplemental data and primary data can provide significant accuracy improvements. For example, GPS technology may not be highly accurate, but when supplemented with other Supplemental data from beacons 600 and trackers 700, it can provide valuable information. For instance, knowing the general location of a beacon 600 via GPS 630 and the general location of a tracker 700 via GPS 730, and also knowing the facing angle of the tracker 700 from a digital compass 737, the tracker 230 can be rotated (via the positioning subsystem 236) towards the tracker 215 using basic trigonometry and calculations of the control subsystem 234.

Additionally, in at least one implementation, taking a mathematical integral of the accelerometer data on the beacon 600 will yield velocity of travel. This velocity combined with the angle of travel 905 of the beacon 600, received at least in part from a digital compass 650, and the last known location from a GPS 625, one can determine where the beacon 600 will be during the next moment in time (assuming a constant travel and path). By performing these predictive calculations repeatedly, and averaging them with the “actual” GPS calculations, the movement over time can be “smoothed” for use by the tracker 700. Similarly, by knowing the tracker 700 location via GPS 925, and its facing angle 915 via digital compass 737, the “smoothed” location of the beacon 600 can be pointed at by the tracker 230 (with Supplemental Tracker 700).

Returning to FIG. 10, FIG. 10 depicts an illustration 1000 showing a method for calculating an angle of tilt for a tracker 700 to aim at an emitter 600. In particular, in at least one implementation, the angle of tilt or upward/downward rotation for a tracker 700 to move to point vertically at a beacon 600 can be calculated via the Pythagorean theorem if the distance 1010 from a top view (via GPS data) is known, and if an altitude 1005 of a beacon 600 via an altimeter is known. Similarly if a distance 1020 between the tracker 700 and the beacon 600 are known from sonar or ultrasonic devices (620 and 625; 720 and 725), and an altitude (or altitude differential) is known 1005 from altimeter devices of 600 and 700, then the angle 1015 can be known.

This angle can be used to determine whether to continue 815 tilting or up or down, moving motors 820 or stopping motors 825, in cases where the primary data 805 is not available. These methods can also be used as a source of primary data to determine where to tilt to without primary data at all.

In at least one implementation, a mounted device 242 may be a smartphone or similar device such as a tablet or small camera (or even a smart light or smart microphone), which may or may not be the same device as the UI System 220. The mounted device 242 may have all of the capabilities of a smartphone, including video recording capabilities, location identification capabilities, cellular data and voice transmission capabilities, memory storage capabilities, computational or processing capabilities, object tracking and computer vision capabilities, 3D modeling and calculating and displaying capabilities, Wi-Fi and Bluetooth data sending and receiving capabilities, other sensory capabilities including those related to accelerometers or gyroscopes or altimeters or sonar sensors or GPS sensors or heat sensors or light sensors or audio sensors or touch sensors, programmability using custom-created applications or apps.

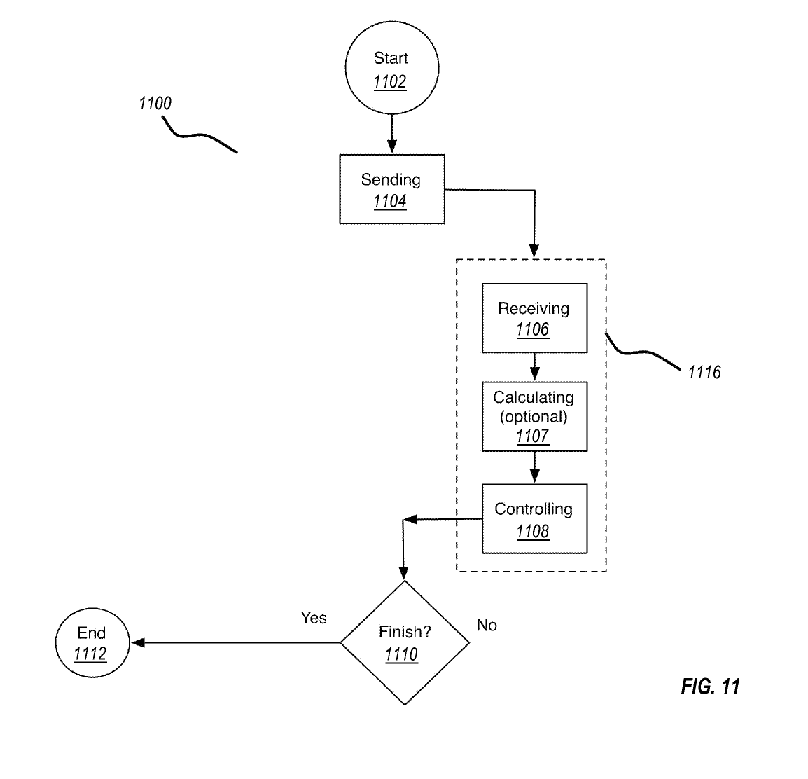

FIG. 11 depicts a block diagram of an implementation of a method for a mounted device 242 (which may be a smartphone or similar device) to send 1104 data to a tracker 230 effective for tracking activities 1116 to be performed by the tracker 230. In at least one implementation, these activities may include those shown in method 300 as well. The data that is sent 1104 by the mounted device 242 may be processed such that most of the calculating 1107 by a tracker 230 becomes unnecessary. A tracker 230 may simply receive 1106 the data from the device 242 and control 1118 motors of the tracker 230 in order to point 104 and 102 at the tracking object 216 or emitter 215.

Alternatively, in at least one implementation, data received 1106 from a mounted device 242 may be combined with data from a sensory subsystem 232 or other data from system 200, including grip system data 250, UI system data 220, and/or emitter system 210 data, to enhance control subsystem 234 calculations 1107, which may include system or method 300 functions or other functions of the present invention or of system 200.

In at least one implementation, data may be sent 1104 by the mounted device 242 to the tracker 230 via any number of means including these: Wi-Fi, Bluetooth, or physical cable or connection between the two which may include device and functioning of a I/O subsystem 246. Additionally, sending 1104 may include data flowing back and forth both directions between the mounted device 242 and the tracker 230, and initiated by either the mounted device 242 or the tracker 230. Method or process 1100 may start 1102 or end 1112 either by direct user intervention or by configurations and automated behaviors programmed into or hardwired into any device or subsystem of system 200.

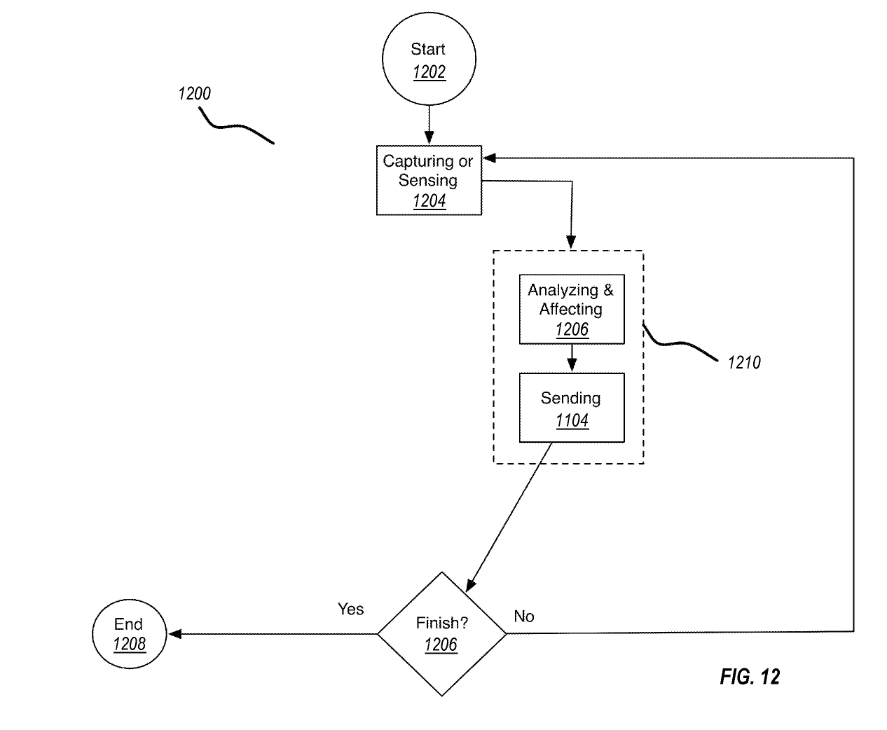

FIG. 12 depicts a block diagram of an implementation of method 1200 for a smartphone's capturing or sensing 1204 data related to a tracking object 216 or emitter 215 or other positional or other data related to these objects of system 200 or other subsystems of system 200. Additionally, the method can include analyzing 1206 (including steps of method 300) and affecting 1206 (including pattern recognition 402, and triangulating with other trackers 900) and sending 1104 tracking control data and other data to a tracking device 230. The data can then be used to control (via control subsystem 234) and/or position (via a positing subsystem 236) tilting and swiveling of motors all effective to aiming 104 and 102 at the tracking object 216 or tracker 215.

In at least one implementation, the mounted device 242 may capture 1204 video or still images, or other data, which may be RF signals or audio signals or other sensory data including GPS, gyroscope, altimeter, and other sensory data associated with 700. The mounted device 242 may analyze the video or other data thus captured 1204 using computer vision algorithms or other algorithms to analyze 1206 a face or other shape or color or combinations of shapes or colors or RF signals or audio signals or other sensory data associated with 700.

The mounted device 242 may also factor in or affect 1206 its data analysis with configuration data or other data of system 200 including data entered from a UI System 220 or from the tracker 230 or mounting system 240 or grip system 250. Such configuration data or other data may enable steps or portions of methods or systems described herein.

System 1200 may capture positioning data 1204 from an outside source and directly send 1104 that data to a tracking device 230. In at least one implementation, system 1200 may capture data from an outside source, such as an emitter location generator (“ELG”) 120, and analyze and affect 1206 data before sending 1104 it to a tracker 230. In particular, in at least one implementation, an ELG 120 may comprise one or more sensor modules capable of tracking one or more emitters. The information received from the ELG 120 may then be provided to a tracker 215, such that the tracker 215 need not gather its own data. In contrast, in at least one implementation, the ELG 120 provides data that is used by the tracker 215 to supplement its own data. Further, in at least one implementation, an ELG comprises a tracker 215 that is communicating tracking information to a primary tracker. Further still, in at least one implementation, an ELG 120 comprise a distinct unit from a tracker 215 and needs a tracker to fully function. Accordingly, in at least one implementation, the ELG 120 can perform the bulk of the tracking functions, and the tracker 215 can merely provide the control functions of positioning the mounted device 242.

Configuration from the same mounted device 242, which may be a smartphone 222 or another smartphone 222 or related device, may also affect the functioning of or be affected by the functioning of system or method 1100 or 1200 or system or method 300 or system 200 and its subsystems generally. More generally, all data from system 200 may be accessible to mounted device 242, and all data that can be analyzed or computed or saved by the mounted device 242 may be available to system 200 via Wi-Fi or Bluetooth or physical cable or other mechanism of Device I/O subsystem 246 which may be separate or integrated into the mounted device 242 with or without the aid of this invention.

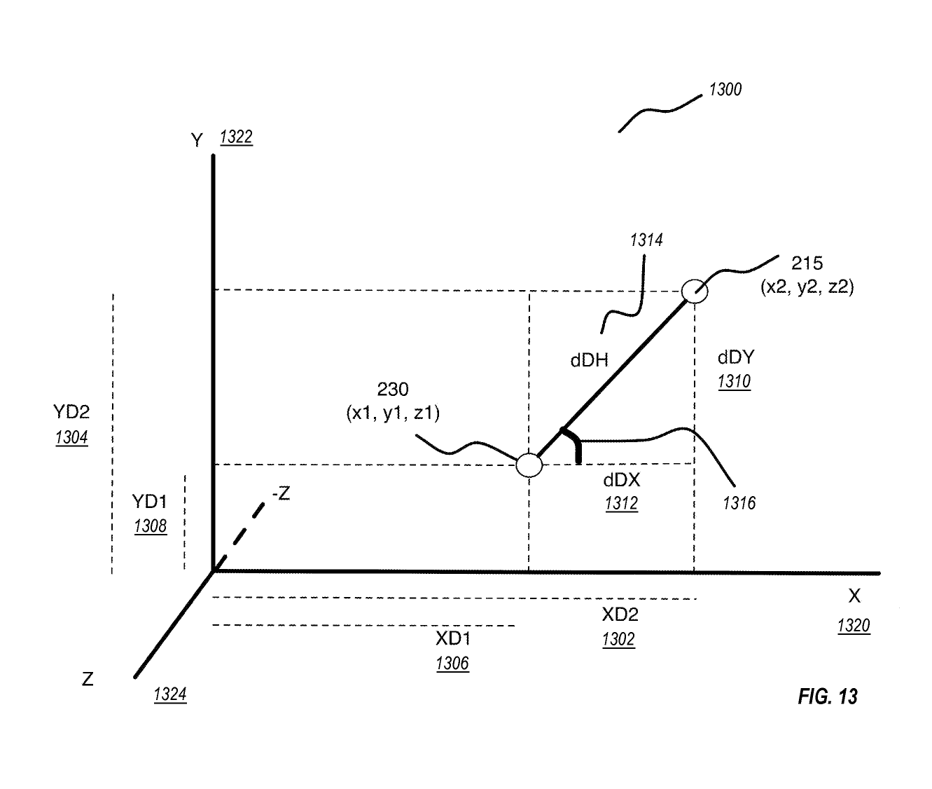

FIG. 13 depicts an illustration of a three-dimensional Cartesian coordinate system 1300 showing the location of an emitter 215 and a tracker 230 relative to the x-axis 1320, the y-axis 1322, and the z-axis 1324. An emitter 215 is shown as being located in 3D space, where the x-coordinate is known to be XD2 1302 and the y-coordinate is known to be YD2 1304.

A tracker 230 is shown as being located in 3D space, where the x-coordinate is known to be XD1 1306 and the y-coordinate is known to be YD1 1308. Using the Pythagorean theorem, additional data of this Cartesian coordinate system 1300 can be deduced, including the angle 1316 that the tracker 230 must rotate on the X-Y plane in order to aim at the emitter 215 and the distance dHD between the emitter 215 and the tracker 230 in 3D space.

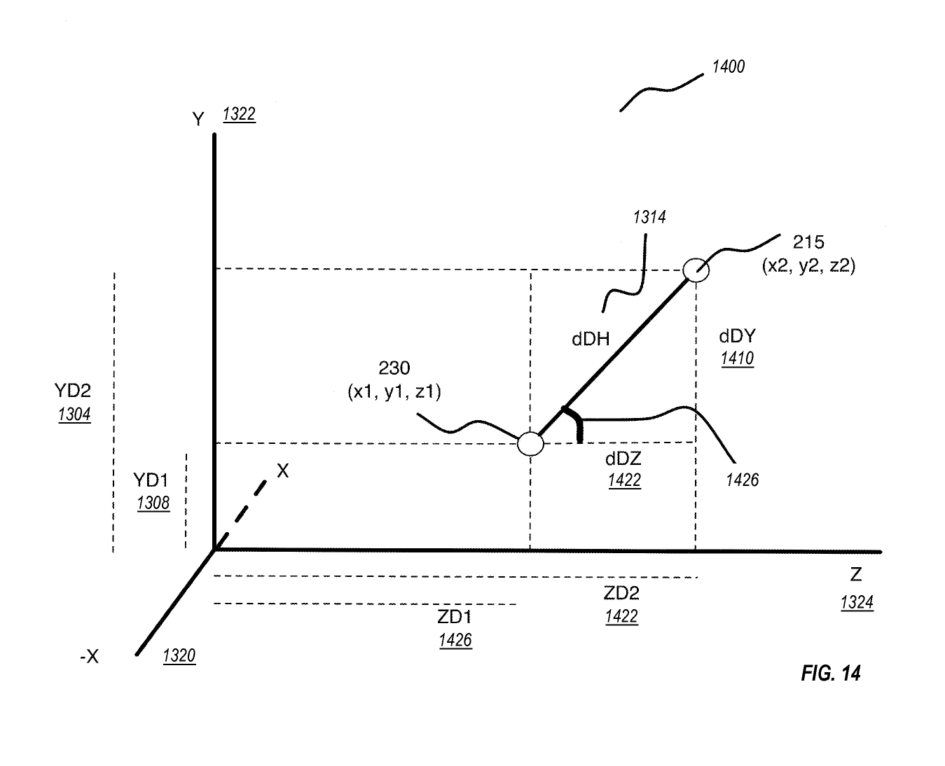

FIG. 14 also depicts an illustration of a three-dimensional Cartesian coordinate system 1400 showing the location of an emitter 215 and a tracker 230 relative to the x-axis 1320, the y-axis 1322, and the z-axis 1324. The coordinate system 1400 may be thought of as rotated 90 degrees around the y-axis in a counter-clockwise direction, but otherwise be the same system with the same emitter 215 and tracker 230 as that of FIG. 13.

Like in FIG. 13, an emitter 215 is shown as being located in 3D space, where the z-coordinate is known to be ZD2 1422 and the y-coordinate is known to be YD2 1304. A tracker 230 is shown as being located in 3D space, where the z-coordinate is known to be ZD1 1426 and the y-coordinate is known to be YD1 1308. Using the Pythagorean theorem, additional data of this Cartesian coordinate system 1400 as well as that of coordinate system 1300 can be deduced, including the angle 1426 on the Y-Z plane that the tracker 230 must rotate in order to aim at the emitter 215 and the distance dHD 1314 between the emitter 215 and the tracker 230 in 3D space, which is the same distance between the emitter 215 and the tracker 230 shown in FIG. 13.

In addition to calculating the angular data as described above, in at least one implementation, an ELG 120 can provide data, such as angular data 1426 and 1316. This data may make it possible for the tracker to calculate where to rotate along the x-y plane and along the y-z plane in order for the tracker 230 to point at the emitter 215. Similarly, if an ELG 120 provides location data of the emitter 215 and the tracker 230 in x, y, z coordinate space, it is similarly possible for the tracker to calculate where to rotate along the x-y plane and along the y-z plane in order for the tracker 230 to point at the emitter 215.

Accordingly, in at least one implementation, using trigonometry illustrated in systems 1300 and 1400, combinations of data (such as some angular and some location or distance data) may also enable a tracker 230 (and algorithms embedded within software code and memory or FPGA or the like) to process or calculate with the help of a microprocessor or micro controller (or possibly with none at all in the case of the FPGA) where to rotate along an x, y, and z axis in order to point 140 at the emitter 215 or tracking object 216. This data of systems 1300 or 1400 may be used with or without other sensory subsystem 232 data to identify how to aim 104 the tracker 230 at the emitter 215 or tracking object 216.

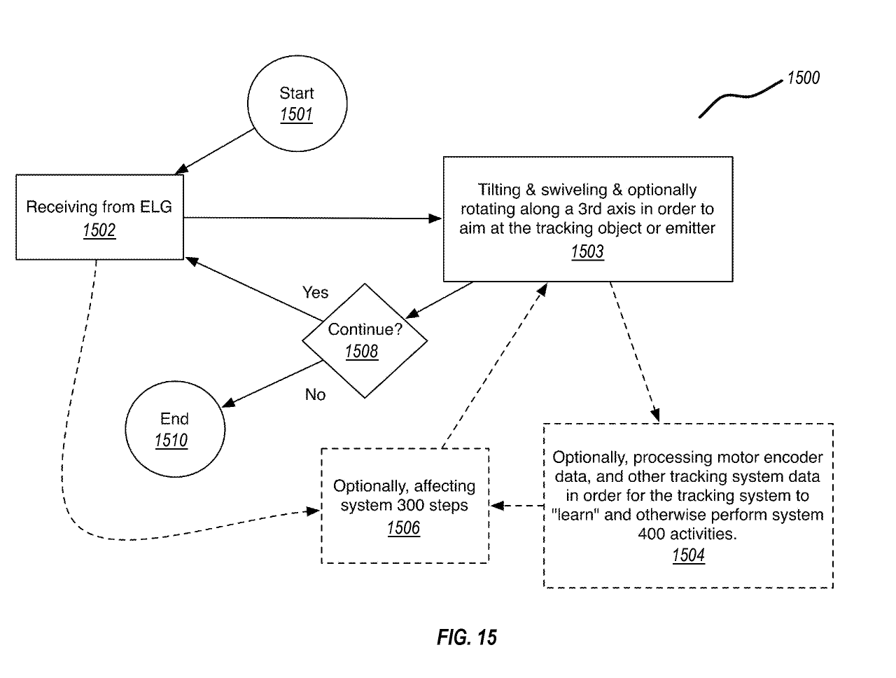

FIG. 15 depicts an illustration of a block diagram 1500 of an implementation of a method for employing data from a ELG 120 in order to tilt & swivel & optionally rotate along a 3rd axis in order to aim at the tracking object or emitter, effective for implementing the present invention. In at least one implementation, the process starts with 1501, which may be initiated by a system 300 function, or some other trigger of system 200.

The tracker 230 receives data from the ELG 1502 either via Wi-Fi, Bluetooth, a hard-cable connection, or by some other means or methods. The kind of data that the tracker receives may be finally calculated angular data 1426 or 1316, or it may be emitter 215 coordinate data (x, y, z) or it may be distance data, such as distance dDX 1312, dDZ 1422, YD2 1304, YD1 1308, or the difference between YD2 and YD1, or other data of system 1300 or 1400 or a similar system of 200. The tracker 230 may also receive other data from the ELG 1502 related to or convertible by the tracker 230 sensory subsystem 232 or control subsystem 234 for optionally further processing by the control system 234 or positioning subsystem 236.

The ELG data 1502 may also be accessible to system 300 processes 1506 in order to augment or improve system 300 functioning. The tracker then may optionally analyze 1506 data from within its system 300 processes, including but not limited to analysis of data from a sensory subsystem 232. The tracker can tilt and swivel 1503 and optionally rotate on a 3rd axis in order to aim 104 at the emitter 215 or tracking object 216 using data 1502 from the ELG 120. Such motor activity 1503 may involve the positioning subsystem 236 and/or the control subsystem 234.

The tracker 230 may perform calculations on the data received 1502, in part based upon algorithms and processes 1506 associated with system 300 steps, in order to actuate or control 234 a positioning subsystem 236. System 300 steps may be affected by configuration data from a UI system 220 or other systems or data of system 200. The positioning subsystem 236 may use encoded motor data resulting from rotations or partial rotations or “clicks” or counts of the encoders to better know where the motors are rotated (and hence where the tracking system 230 is tilted or swiveled or moved along a 3rd axis), and in order to improve the achieve control, feedback, or actuation of the proper swiveling and aiming activities 1504.

In at least one implementation, system 400, along with benefits enabled by system 400 or of “learning” activities, may be enabled based upon encoder and motor movements 1504. Such activities 1504 may loop back to or provide data back to system 300 steps 1536, making them more informed or updated or effective. Such may enable configuration settings to be updated, or benefits of system 300 to be improved.

Receiving data 1502 may be followed directly, in a preferred with tilting & swiveling & optionally rotating along a 3rd axis of rotation (process step 1503) in order to aim the tracker 230 at the tracking object 216 or emitter 215. If the system decision 1508, which may be directly made by user input or by system intervention, is to continue tracking, then system 1500 may continue receiving more data from the ELG 1502. The system may also continue optionally processing that data according to trigonometric formulas implied by systems 1300 and 1400 in order for tracker 230 motor rotations 1503 to be actuated. If the decision 1508 is “no” then tracking may end 1510 temporarily or permanently until by some means of user or system intervention the process is started 1501 again.

Thus, the present invention illustrates and describes devices and methods for enabling a tracker 230 to track using coordinate data from another device ELG 120 (or another device of system 200), angular data from another device ELG 120 (or another device of system 200), distance data from another device ELG 120 (or another device of system 200), or some combinations of these. Implementations of the present invention may lower the cost of construction of the tracker because it may optionally not have to include a sensory subsystem 232 and/or a control subsystem 234. Additionally, implementations of the present invention may allow for a smaller tracker 230 size because the tracker may not need to include the control subsystem 234 and/or the sensory subsystem 232. Further, in at least one implementation of the present invention, the system can allow for enhanced tracking by the tracker 230 using the system 1500 method, integrating both ELG data 1502 and system 300 steps 1506 and/or “learning” from motor encoder data according to system 400 activities 1504.

Additionally, implementations of the present invention, comprise devices and methods for enabling a tracker to track using various data related to one or more emitters 215 and/or trackers 230 as sensed or measured from another device ELG 120, as well as data from its own sensory subsystem 232 or from other subsystems within system 200 or outside of it. In particular, the system can rely upon coordinate data, angular data, distance data, or some combination of these, received from various diverse and distinct systems. As such, implementations of the present invention can provide lower cost-construction of the tracker, smaller tracker size, and enhanced tracking as a result of the processing of more abundant data.

In various implementations of the present invention, trackers 908 and 906 and 904 may be small and low cost and simple because they rely upon ELG 120 data to aim 104 at an emitter 215 or tracking object 216. Additionally, the system may be able to track the emitter more accurately because they can share data and triangulate the location of the emitter 902. Additionally, in a tracking system 800, a tracker 230 may be small and low cost and simple because it relies upon ELG 120 data to aim 104 at one or more emitters 215 and yet it may do so more accurately or pleasingly because it can rely both on trigonometric calculations shown in system 800 as well as data calculations from systems 1300 and 1400 and 1500. Further, in at least one implementation, in a tracking system 500, where the framing of a tracking object 216 may be defined, and in system 600 where paths are defined by a user, the implementation of the framing and tracking may be more accurate if data both from a sensory subsystem 232 is available, and data from an emitter location generator 120 is available.

In systems 1000 and 1100, where a smartphone or other mounted device 242 is used in substitution of a sensory subsystem 232, this tracking may be more accurate if the tracker 230 nevertheless has an ability to receive 1502 and actuate 1503 based upon data from an ELG 120. Furthermore, these systems 1000 and 1100 may not require their associated smartphones or other mounted devices 242 to be used in substitution of a sensory subsystem 232, but only to record video or shine a light or record audio or perform some other useful function with full processing capacities and cycles and bandwidth being devoted to non-sensory-subsystem 232 like activities.

In at least one implementation, system 400 may be more effective in identifying pattern recognition and integration 402 if system 1500 is in effect, and ELG data 1502 is used to effect the motors 1503. System 300 may be more effective with ELG data 1502 inputs as well as with system 400 inputs 1504.

An ELG 120 device and associated methods and frameworks 1300, 1400, and 1500 clearly provide many benefits, including possible reduced costs of building an effective tracker 230, reduced size of a tracker 230 and enhanced functioning of a tracker 230 and tracking system 200. A tracker 230 may be able to focus its resources on recording video, rather than using its sensory subsystem 232 to both track and record video, if an ELG 120 device and associated frameworks and methods 1300, 1400, 1500 can be used to track an emitter without the use of a tracker's sensory subsystem 232. Such focusing on recording video by the tracker 230 may result in the recorded video being of higher quality.

In at least one implementation, an emitter system 210 may include supplemental emitter sensors 600 and information that can be used by a tracker 230 and its associated supplemental tracker sensors 700 to track in ways that are not possible with line-of-sight tracking systems such as IR based emitters 215 and trackers 230. Thus when line-of-sight is not possible, or at times when such data is not available in real-time, a tracking system 200 can still function successfully when an appropriate tracking method 800 is employed which can combine primary data 805 from a line-of-site system and supplemental data 810 in order to determine whether to continue tracking 815 or stop motors 825.

In at least one implementation, motor encoder data 404 can be combined with control data 402 to enable pattern recognition 402, which can be implemented and acted upon for tracking 300 and positioning 405 activities. By having multiple trackers 230 tracking a single emitter 215 or emitter group 215 or 210, one or more trackers 230 which do not have line-of-site, or do not have good tracking data, might know which direction to position 405 or track 300 by using encoder data transmitted from other trackers 230 and their position, and basic geometry and trigonometry.

Additionally, in at least one implementation, a mounted device 242 may be a smartphone 242 or other device 242 that senses a tracking object 216 or emitter 215 or tracking environment 100. This mounted device 242, which may be a smartphone, may capture 1204, analyze 1206, and/or generate data and send 1104 data for affecting the motors via a tracker 230 and positioning subsystem 236 of an associated and possibly separate tilt and swivel tracking device 230 in order to follow or point 104 and 102 at a tracking object 216 or emitter 215. As such, in at least one implementation, the tracking device 230 may not need to be as sophisticated, as expensive, or as heavy as it would with its own included sensory 232 and or control 234 subsystems.

Additional benefits may include the tracking 1016 of the tracking device 230 may be more accurate because of combining captured or sensed data 1204, which is analyzed and/or affected and sent 1,210 data, and sensory subsystem 232 data or other data available to the control subsystem 234 of the tracker 230 in order to effect tracking 1,016 that may be (1) more accurate, (2) more responsive, (3) more anticipatory, and (4) more affected by the tracking environment 100 or system 200

As used herein, the modules, components, flowcharts, and box diagrams are provided for the sake of clarity and explanation. In various alternate implementations the modules, components, flow charts, and box diagrams, may be otherwise, combined, divided, named, described, and implemented, and still fall within the description and invention provided herein. Similarly, various components and modules may be otherwise combined to perform the same or different functions and still fall within this description and invention.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A system for tracking a cinematography target, the system using multiple components to identify and track the target, the system comprising:
an emitter configured to attach to a target and to provide a tracking indicator;
a tracker configured to receive tracking data from a separate tracking data reception device and based upon the received tracking data to actuate one or more motors that cause an attached cinematography device to point towards the tracking indicator;
the tracking data reception device configured to generate information relating to the location of the tracking indicator, the tracking data reception device comprising one or more sensor modules that are configured to identify a location of the tracking indicator relative to the tracking data reception device; and
a user interface device configured to receive commands from a user and communicate the commands to the tracker.

2. The system as recited in claim 1, wherein the attached cinematography device comprises a smart phone.

3. The system as recited in claim 2, wherein the tracking data reception device comprises the smart phone.

4. The system as recited in claim 3, wherein the tracking data reception device comprises the smart phone.

5. The system as recited in claim 1, wherein the tracker comprises an integrated camera.

6. The system as recited in claim 3, wherein the smart phone comprises a video camera that both tracks the tracking indicator and records the target.

7. The system as recited in claim 1, wherein the tracking data reception device comprises a supplemental tracker that transmits information to the tracker.

8. The system as recited in claim 1, further comprising three or more tracking data reception devices, wherein the three or more tracking data reception devices are configured to triangulate the relative location of the emitter.

9. The system as recited in claim 1, wherein the tracker comprises one or more primary sensors modules that are configured to identify a location of the tracking indicator relative to the tracker, such that the tracker actuates the one or more motors based upon the tracking data received from the tracking data reception device and the tracking data received from the one or more primary sensors.

10. The system as recited in claim 1, wherein the emitter comprises one or more emitter sensor modules that communicate sensor information to the tracker.

11. The system as recited in claim 10, wherein the one or more emitter sensor modules comprise a GPS module that communicates to the tracker a GPS location associated with the emitter.

12. The system as recited in claim 1, wherein the one or more motors comprises encoded motors that provide feedback to the tracker.

13. A computer-implemented method at a tracking device for tracking a cinematography target that has been associated with an emitter, the method comprising:
receiving an indication to associate with a separate tracking reception device, wherein the tracking data reception device comprises one or more sensor modules that are configured to identify a location of an emitter relative to the tracking data reception device;
receiving secondary tracking data from the tracking reception device, wherein the secondary tracking data comprises information related to the current location of the emitter; and
actuating at least one motor to cause an attached cinematography device to point towards the emitter.

14. The method as recited in claim 13, further comprising:
receiving primary tracking data from one or more sensors integrated within the tracking device; and
analyzing both the primary tracking data and the secondary tracking date to determine an actuation sequence for the at least one motor.

15. The method as recited in claim 14, further comprising:
identifying that the one or more sensors associated with the tracker lack a direct detection of the emitter;
calculating, based upon the secondary tracking data, the actuation sequence.

16. The method as recited in claim 14, further comprising:
calculating, based upon both the primary tracking data and the secondary tracking data, the actuation sequence.

17. The method as recited in claim 13, further comprising:
analyzing, at the tracking device, both the primary tracking data and the secondary tracking date to identify one or more patterns in the movements of the emitter; and
calculating, based upon the identified one or more patterns, an actuation sequence.

18. The method as recited in claim 13, wherein the tracking reception device comprises a smart phone attached to the tracker.

19. The method as recited in claim 13, further comprising:
receiving secondary tracking data from three or more tracking reception devices, wherein the secondary tracking data comprises triangulation information for the emitter.

20. A computer program product for use at a computer system, the computer program product comprising one or more computer storage media having stored thereon computer-executable instructions that, when executed at a processor, cause the computer system to perform a method for tracking a cinematography target that has been associated with an emitter, the method comprising:
receiving an indication to associate with a separate tracking reception device, wherein the tracking data reception device comprises one or more sensor modules that are configured to identify a location of an emitter relative to the tracking data reception device;
receiving secondary tracking data from the tracking reception device, wherein the secondary tracking data comprises information related to the current location of the emitter; and
actuating at least one motor to cause an attached cinematography device to point towards the emitter.
